(19) United States
(12) Patent Application Publication
(10) Pub. No.: US 2009/0001709 A1
(43) Pub. Date: Jan. 1, 2009

(54) Multi-Ply Security Paper

(75) Inventors: Friedrich Kretschmar, Munchen (DE); Mario Keller, Bad Endorf (DE); Ralf Liebler, Gmund (DE); Jurgen Ruck, Schliersee (DE); Wolfgang Wensauer, Gmund (DE); Theodor Burchard, Gmund (DE); Thomas Bodendieck, Dresden (DE); Gregor Grauvogl, Oberhaching (DE); Horst Reigl, Miesbach (DE)

Correspondence Address: GREENLEE WINNER AND SULLIVAN P C, 4875 PEARL EAST CIRCLE, SUITE 200, BOULDER, CO, 80301, US

(73) Assignee: Giesecke & Devrient GmbH, Munich (DE)

(21) Appl. No.: 11/909,115

(22) PCT Filed: Mar. 14, 2006
(86) PCT No.: PCT/EP2006/002333

§ 371 Date: Sep. 19, 2007

(30) Foreign Application Priority Data
Mar. 23, 2005 (DE) 10 2005 013 474.2
Sep. 23, 2005 (DE) 10 2005 045 566.2

(51) Int. Cl. B42D 15/00; D21F 1/44

(52) U.S. Cl. 283/94; 283/113; 162/110; 162/123; 162/232; 162/267

(57) ABSTRACT

The present invention relates to multi-ply security paper for manufacturing security or value documents, such as banknotes, identification cards and the like. Into a first paper ply (52) is introduced an endless security element (54) that is freely accessible on at least one side of the paper ply (52). The first paper ply (52) is covered on the freely accessible side of the security element (54) by a second paper ply (56), and the second paper ply (56) exhibits one or more openings (58) in the region of the security element (54).

The present invention relates to multi-ply security paper for manufacturing security or value documents, such as banknotes, identification cards and the like.

For protection, security papers or value documents are often furnished with authenticity features, such as watermarks, embedded security threads and the like, that permit the authenticity of the security paper or value document to be verified, and that simultaneously serve as protection against unauthorized reproduction.

Within the meaning of the present invention, the term “security paper” refers to the unprinted paper that is customarily present in quasi-endless form and is further processed at a later time. A document that is completed for its intended use is referred to as a “value document”. Value documents within the meaning of the present invention are especially banknotes, stocks, bonds, certificates, vouchers, checks and valuable admission tickets and other papers that are at risk of counterfeiting, such as passports and other identity documents, as well as product protection elements such as labels, seals, packaging and the like. In the following, the simplified designation “security paper” or “value document” includes all such documents and product protection means.

In the past, especially such authenticity features that can be introduced into the security paper only during manufacture have proven reliable. A first kind of authenticity feature, such as watermarks, security threads, chemically reactive additives or mottled fibers, serves the visual authenticity check by a person. Although these features are visually perceptible, they guarantee high security, since the paper furnished with such authenticity features can be manufactured only with elaborate machines to which a counterfeiter has no access and whose purchase or reproduction is not economically worthwhile for counterfeiting purposes.

In addition to the features that are identifiable visually and without auxiliary means, security papers have long also been furnished with authenticity features of a second kind that are detectable only with the aid of special detection apparatuses. With this kind of feature, a counterfeiter additionally has the problem of having to first identify the presence of a feature and its special properties.

Many security papers and value documents include authenticity features of both cited kinds to facilitate an authenticity check at different levels. For example, a security thread for embedment in banknotes or other value documents can exhibit an inverse lettering that is visually perceptible in transmitted light and, additionally, a magnetic code that is machine-readable only.

Based on that, the object of the present invention is to propose a security paper of the kind mentioned above that exhibits high counterfeit security.

This object is solved by the features of the independent claims. Developments are the subject of the dependent claims.

Multi-ply security paper is a security paper combined from multiple layers, the merging of the layers being able to occur already at paper manufacture or only after paper manufacture. In both variants, there are multiple different principles according to which the security paper can be furnished with one or more authenticity features. Foreign elements can be applied to the security paper, visually or machine-verifiable measures can be carried out on the individual layers that make up the multi-ply security paper, and intercalations can be introduced between two or more of the individual layers.

The multi-ply security paper includes at least one ply composed of paper. The further plies can likewise be formed from paper, as well as from other materials, for example by plastic foils.

The foreign elements can be applied, for example affixed, to the security paper in endless form both at and after paper manufacture, for example as strips or bands, or in the form of individual tag-shaped elements. For the intercalations between the layers, individual elements, such as fibers, planchets, pigments, imprints and the like, or endless material, such as security threads, security bands, nets, gratings, woven material or foil webs, may be used.

At paper manufacture, a number of measures to be carried out on the individual paper layers are useful. For example, the individual layers can exhibit differing thickness or differing composition as a whole or only in some regions. The latter can be achieved for example by additives when manufacturing the individual layers, or by forming the individual layers from different fibers. Further, the individual layers can exhibit a different areal structure. This includes, for example, authenticity features, such as through openings, watermarks or interruptions, in one or more of the individual layers. A subsequent deformation of the paper plies, for example with the aid of a dandy roll, may also be used.

If the paper plies are joined together only after paper manufacture, for example by lamination, then authenticity features can be produced, on the one hand, with the measures just mentioned, so especially by varying the thickness, the composition or the areal structure of the paper plies. Additional possibilities result if different materials, such as paper and plastic foils, are combined with each other. One, multiple, or even all of the different material layers can then be provided with authenticity features, particularly high counterfeit protection being achieved when the authenticity features from different layers establish a functional interaction with each other. For example, the pieces of information present in different layers can complement each other to form an aggregate piece of information, or the effect of an authenticity feature in one layer can require the presence of a further feature in another layer.

In a first aspect of the present invention, into a first paper ply in a generic security paper is introduced an endless security element that is freely accessible on at least one side of the paper ply. On the freely accessible side of the security element, the first paper ply is covered by a second paper ply that exhibits one or more openings in the region of the security element. Preferably, the dimension of the opening(s) perpendicular to the running direction of the endless security element is less than the width of said security element, such that it does not extend beyond the security element.

The endless security element can especially be formed by a security thread or a wide security band. Here, security threads exhibit a width of 2 mm or less, typically of about 1 mm. In the context of this description, wider endless security elements are referred to as security bands. They especially exhibit a width of 4 mm to 20 mm, in some cases even up to 30 mm.

While the narrower security threads are usually embedded in the first paper ply, the wide security bands typically divide the first paper ply into two parts such that they are visible and accessible on both sides of the paper ply. Here, in the border regions of the security band, a characteristic deckle edge is advantageously formed that cannot be copied by cutting or punching. The security element can also be affixed in the first paper ply with an adhesive.

Furthermore, the endless security element can be furnished with optically variable effects, especially with a diffraction pattern, a hologram, a color-shift effect or another interference layer effect. It can also be provided with a print image, especially positive or inverse characters.

The opening of the second paper ply can be provided, for example, in the form of a strip-shaped interruption extending along the endless security element. Such an interruption can be closed with a tear-openable release strip at manufacture such that an initially closed security paper is created into which an opening can be introduced at a later time. Also any other hole shapes may be used for the openings, such as a regular sequence of round or angular interruptions. In an advantageous embodiment, the openings in the second paper ply are filled with a transparent material, especially a polyurethane adhesive.

According to a preferred embodiment of the security paper according to the present invention, the first paper ply includes a watermark, and the second paper ply, in the region of the watermark, an interruption in which the watermark stands out clearly.

In an advantageous variant of the present invention, the first paper ply exhibits a grammage of 60 to 80 g/m², especially of 65 to 70 g/m², while the second paper ply exhibits a grammage of 15 to 45 g/m², especially of 20 to 25 g/m². In another, likewise advantageous variant, the relationships are reversed, and the first paper ply exhibits a grammage of 15 to 45 g/m², especially of 20 to 25 g/m², while the second paper ply exhibits a grammage of 60 to 80 g/m², especially of 65 to 70 g/m².

In a method for manufacturing an above-described security paper, it is provided that
a first paper web is formed, and an endless security element is introduced into the first paper web such that the endless security element is freely accessible at least on one side of the paper web,
a second paper web is formed that, while still in the wet state, is merged and firmly joined with the first paper web such that it covers the freely accessible side of the security element,
wherein into the second paper web are introduced one or more openings that, after the merger with the first paper web, come to lie in the region of the endless security element.

The manufacture of the first and/or second paper web preferably occurs in a direct-current cylinder mold paper machine. Alternatively or additionally, the first and/or second paper web can be produced in a pressure former, in which the paper pulp is jetted onto a cylinder mold.

In a particularly advantageous development of the method, the second paper web is produced on a cylinder mold whose holes are closed in sub-areas. In this way, the sheet formation is suppressed in these sub-areas and fiber-free regions, i.e. openings, are created in the second paper web. The closing of the holes can advantageously occur by applying, especially affixing, a cover strip, by partial printing on the mold with a lacquer layer or by a cover ring abutting the lateral surface of the cylinder mold from inside. It is also possible, at paper manufacture, to allow the endless security element to run onto the cylinder mold such that it closes the holes of the cylinder mold at the sites run onto.

According to a second aspect of the present invention, in a generic security paper, at least two paper plies produced with different fibers are combined with each other. The at least two paper plies can especially be formed from fibers of different colors or different lengths, or from fibers having different feature additives.

In one embodiment, the paper plies produced with different fibers are formed having complementary interruptions and complement each other to form a combination paper ply. This combination paper ply exhibits no greater thickness than the individual plies, since the contributions of the individual plies to the combination paper ply are each disposed in interruptions in the other paper plies. In the simplest case, the paper plies consist of two complementary stripe patterns such that an alternating sequence of stripes of the two individual paper plies results as the combination paper ply.

In another embodiment, the at least two paper plies produced with different fibers exhibit interruptions in the form of vertical or horizontal stripes and are stacked in the security paper such that they form a checkerboard pattern.

In another advantageous embodiment, a first paper ply including a watermark is formed from short fibers and, to increase the tensile strength, combined with a second, thinner paper ply composed of long fibers. Advantageously, the first paper ply composed of short fibers is even embedded between two thinner paper plies having long fibers. In this way, the high tensile strength of the long-fiber layer(s) is combined with the pronounced watermark effect of the short-fiber layer.

In a further advantageous embodiment, a first paper ply including a watermark is covered by a second paper ply that is formed with transparent fibers in the region of the watermark, and with ordinary, non-transparent fibers outside the region of the watermark. The watermark is then protected by the transparent fiber region and nevertheless clearly perceptible.

It is understood that the at least two paper plies produced with different fibers can be combined with further contiguous or interrupted paper plies. They can also be combined with a security element that is preferably visible through the paper plies at least in a sub-area, for example an opening.

A further aspect of the present invention relates to a method for manufacturing a security paper, in which
in a first wet end of a paper machine, a first paper web is formed and, if applicable, provided with individualization features, such as an opening or a watermark,
in a second wet end of a paper machine, a second paper web is formed,
the second paper web is merged and firmly joined with the first paper web via a pickup belt, and in which
from the second paper web, still in the wet state, paper fibers are removed by means of a suction apparatus, preferably in register with the individualization features of the first paper web.

The suction apparatus can be a perforated suction roll or a suction pipe. Here, the suction pipe can suction in pulsed or, alternatively, continuous mode. The openings of the suction roll or of the suction pipe can be formed arbitrarily such that also more complicated hole shapes, such as stars, alphanumeric characters etc., can be produced.

In a variant of the present invention, the fibers of the second paper web are only partially removed by the suction apparatus to produce regions of smaller thickness in the second paper web. The regions of reduced thickness in the second paper web can, for example, be in register with watermark regions of the first paper web in order to make them bright.

According to another variant, the fibers of the second paper web are completely removed by the suction apparatus to produce openings in the second paper web. These openings are preferably produced in register with openings in the first paper web. In this way, the openings in the first and second paper web can complement each other to form a see-through hole. Preferably, the openings in the first paper web are produced by so-called e-types on a cylinder mold, while the opening in the second paper web is formed as a through-strip with the continuously suctioning suction pipe and the e-type opening and strip opening come to lie one on top of another. Of course, it is also possible to dispose, additionally, a strip-shaped security element between the paper webs or in one of the paper webs, the security element in preferred embodiments lying in the region of the openings. Here, the width of the security element can correspond to the width of the openings, but also be smaller or larger.

In a particularly expedient embodiment of the method, the suction apparatus is disposed between the second and the first wet end such that it draws off the paper fibers of the second paper web on their way to the first paper web. However, it is also possible to dispose the suction apparatus after the merging point of the first and second paper web. In this case, the paper fibers of the second paper web are advantageously drawn off through openings in the first paper web.

To ensure the register accuracy of the openings in the first and second paper web, it is useful to produce the first paper web on a cylinder mold and to drive the suction apparatus, especially the perforated suction roll, in register with this cylinder mold.

The cited register-accurate openings of the two paper webs are advantageously combined with a security element whose respective security features are then visible from both sides of the security paper. As the security element, especially a security thread, preferably a two-sided security thread, such as a double hologram security thread, a double-ink-layer security thread or the like may be used. The security element can also exhibit, in the running direction of the paper web, an element that is in register with the document to be manufactured. The security element is then introduced in longitudinal register, which, for security threads, can occur for example with the aid of a direct thread drive.

Especially for cramped space conditions between the first and second wet end, it can be useful to design the suction apparatus in the shape of a trapezoid or triangle to obtain a sufficiently large surface of contact with the second paper web.

In a further advantageous embodiment of the method, a suction apparatus is used that is formed as a suction wheel composed of multiple segment plates.

Such a suction apparatus can generally be used in paper manufacturing to produce thin sites or openings in a wet paper web. The suction apparatus is formed by a suction wheel composed of multiple segment plates, one or more intermediate plates that form the extraction openings for drawing off a material/water mixture from the wet paper web being provided as segment plates and, disposed on both sides of the intermediate plates, two cover plates that serve to define the edge. At least a portion of the segment plates expediently exhibits channels connected in each case with the extraction openings for drawing off the material/water mixture. To prevent the sticking of fibers, the regions of the intermediate plates adjoining the extraction openings are advantageously recessed.

In addition, a fixed vacuum device can be provided that, in operation, drags on the surface of at least one of the cover plates of the rotating suction wheel and that, for drawing off the material/water mixture, is connected via one of the channels with the extraction opening that is in contact with the paper web in each case.

According to an advantageous development of the present invention, the drawing-off device is covered with a flexible plastic mask that exhibits gaps in the form of patterns, characters or codes in the region of the extraction openings. These gaps can be embodied very finely and designed for example in the form of alphanumeric characters or finely engraved graphic symbols. They can also form patterns that are continuous or disposed in perfect register.

In a further aspect of the present invention, the invention includes a method for manufacturing a security paper, in which, in a wet end of a paper machine, a paper web is formed on a cylinder mold and lifted up from the cylinder mold by means of a carrier belt, and in which the lifting up of the paper web is supported by a suction device disposed in the immediate vicinity of the cylinder mold and at a short distance from the carrier belt. Here, in the suction device, preferably a negative pressure is produced that is greater than the negative pressure in the interior of the cylinder mold by at least 0.1 bar, particularly preferably by about 0.2 bar. With the aid of such a suction device, the formed sheet can be detached from the cylinder mold of the paper machine especially cleanly and without rips.

In an advantageous embodiment, the suction device is formed by a rotatable suction roll that is preferably driven in register-accurate synchronism with the cylinder mold of the wet end. In an advantageous embodiment, the suction roll exhibits a perforated roll shell that is surrounded by a perforated rubber blanket and a felt of defined permeability.

The described method is particularly suitable for such manufacturing variants in which a watermark is introduced into the paper web on the cylinder mold. Due to the different paper thickness, in the region of the watermark, the distance of the suction device to the cylinder mold is then expediently adapted to the local paper thickness.

The present invention also includes, for manufacturing paper in a paper machine, a mold that exhibits elevations and depressions for producing watermark regions and in which, in the depressions, patterns are provided that facilitate the paper detachment from the mold.

In an advantageous variant of the present invention, the elevations and depressions for producing bar watermarks are disposed bar-like next to one another. Particularly advantageously, the patterns are formed by grooves, especially by grooves milled into the depressions. The patterns in the depressions lead to a more even deposit of pulp on the mold, improved removal and thus to a more uniform brightness in the watermark regions of the produced paper web.

A further aspect of the present invention comprises a method for producing a through opening in a multi-ply security paper, in which
a first paper web is formed and provided with an opening,
a second contiguous paper web is formed that, still in the wet state, is merged with the first paper web,
the merged first and second paper web are guided between a first- and a second-web-side carrier felt, and
the second-web-side carrier felt is lifted up from the merged paper web to pick up a sub-area of the second paper web in the region of the opening of the first paper web and, in this way, to produce a through opening in the merged paper web.

Here, the second-web-side carrier felt is expediently acted on with a suction pressure S₂, and the first-web-side carrier felt is acted on in the regions outside the opening with a suction pressure S₁ that is greater than S₂, such that the second paper web cannot be lifted up in these regions. In one embodiment of the method, no suction pressure is applied to the first-web-side felt in the region of the opening, which can be achieved, for example, by pulsed suction. Advantageously, in the region of the opening, the first-web-side carrier felt is even acted on with a counter blowing pressure, especially an air jet, water jet or a laser beam, to support the lifting up of the second paper web in this region.

According to a further aspect of the present invention, in a generic security paper, in at least a first paper ply of the security paper, a luminescent substance and, if applicable, one further feature substance are homogeneously distributed in the volume of the paper ply, this first paper ply exhibiting, at least in a sub-area, at least two different paper thicknesses.

Since the luminescent substance is distributed in the paper homogeneously, the different paper thickness is reflected in the amount of the luminescent substance present, or of the luminescent radiation emitted, i.e., in regions having thicker paper, more luminescent substance is present per unit area than in regions having thinner paper, and consequently also the intensity of the luminescent radiation is higher in regions having thicker paper than in regions having thinner paper.

If now, depending on the position of a sensor over the finished document, the intensity of the luminescent radiation is found to be lacking, the thickness of the paper at this position can be concluded and a layer thickness profile of the paper drawn up. The special advantage now consists in the fact that, at paper manufacture, one can incorporate into the paper, for example in the form of a barcode, a very particular thickness modulation that can easily be measured with the method according to the present invention. Only when the measured intensity curve corresponds to the incorporated thickness modulation is it an authentic document. Since a modification of the thickness modulation at paper manufacture is very easily possible, the security paper can be provided with a plurality of widely differing codes. Additionally, the number of codes can be expanded considerably by incorporating further feature substances.

Here, as luminescent substances, all fluorescent and phosphorescent substances may be used that, following appropriate excitation, emit light in the visible, UV and IR spectral range. Preferably, luminescent substances that emit outside the visible spectral range are used. For example, substances such as those disclosed in EP 0 053 183 B and EP 0 052 624 B can be used as luminescent substances.

The concentration of a luminescent substance in relation to the weight of the fully sized paper usually ranges from 0.05 wt. % to 5 wt. %, preferably from 0.1 wt. % to 1 wt. %.

Preferably, the luminescent substance is transparent in the visual spectral range such that it is not easily visually perceptible. The spectrum of available luminescent substances and their optically verifiable properties is very large, so that a potential fraud, even if he knows that a luminescent substance is present, would have to conduct an elaborate analysis to find the right luminescent substance and that substance's optical property that is verified by the appropriate sites. For machine verification, preferably luminescent substances are suitable that are not available over the counter, and that exhibit special optical properties and are detectable only with measuring devices that are specially tuned for this. Thus, for example, luminescent substances having anti-Stokes or quasi-resonant behavior can be used. Preferably, luminescent substances are used in which both the excitation and emission spectrum lie outside the visible range.

The luminescent substances are incorporated into the paper in that they are, for example, added to the paper pulp at paper manufacture and homogeneously distributed therein by stirring the paper pulp.

The luminescent substance used can be combined with one or more additional luminescent substances, but also with one or more additional feature substances. Here, all materials that can be incorporated into the paper pulp at paper manufacture and are machine-perceptible, so in other words exhibit a physically or chemically measurable or detectable effect, are suitable as feature substances. Substances having electrical and/or magnetic properties can be used here, so for example, electrically conductive pigments, such as metal particles, electrically conductive polymers, magnetizable iron oxide or iron particles and paramagnetic particles, for example composed of Ni or Mn. The concentration of a feature substance in relation to the weight of the fully sized paper is usually about 1 wt. %.

The feature substances can be processed as paper fillers at paper manufacture. Methods for this are known to persons skilled in the art.

The first paper ply further exhibits, in at least one sub-area, thickness modulations, i.e. regions in which the security paper has different thicknesses. Here, every conceivable form is possible. In the simplest case, a region having two different thicknesses is present in the paper ply. The different paper thicknesses can be produced by various techniques. Windows can also be incorporated into the paper ply, that is, regions that exhibit a paper thickness of zero.

Preferably, however, the thickness modulation is realized in the form of a watermark. Here, the watermark can be incorporated into the paper ply in the creation process, or embossed subsequently. The thickness modulation here can exhibit any conceivable form. In the simplest form, the watermark constitutes a barcode. For example, the watermark can also be formed as a two-dimensional areal code in the manner of a checkerboard. But also complicated watermarks, for example portraits, having many different paper thicknesses that are perceptible in the finished paper as different grayscales, can be manufactured and used according to the present invention.

In the manufacture of a bar watermark in the form of a barcode, the manufacturing process for security paper having window threads can be utilized, as is described for example in EP 059056 A. This method is carried out on a paper machine having a cylinder mold. In contrast, in a paper machine having an endless wire, the bar watermark is embossed in the paper web via the dandy roll after paper manufacture, creating the desired thickness modulations.

The paper of the first paper ply usually exhibits a weight of 65 to 120 g/m², a density of 500 to 1000 kg/m³ and a thickness of 50 to 200 μm. For an average paper thickness of 100 μm, the thickness of the regions appearing brighter in transmitted light is about 85 μm or less, and the thickness of the regions appearing darker in transmitted light, about 15 μm or more.

Preferably, the paper of the first paper ply exhibits a weight of 70 g/m², an average thickness of 100 μm and a density of 700 kg/m³. Here, the regions appearing brighter in transmitted light exhibit a thickness of about 70 μm.

In a further embodiment, the thickness differences in the paper are not visually perceptible. This is achieved in that the thickness differences in the paper are kept very small. Here, the minimum or maximum paper thickness in the watermark is 1 to 10%, preferably 1 to 5%, below or above the average paper thickness. In transmitted light, paper thickness modulations that are, for example, in the range of 105 μm to 115 μm, are no longer perceptible as a watermark with the naked eye, but are indeed detectable with a sensor.

A further possibility for concealment consists in overprinting the regions of different paper thicknesses. Preferably, printing inks are used that do not absorb in the spectral ranges in which the feature substance is excited and emits, i.e. that are transparent.

In an inventive embodiment of the multi-ply security paper, the first ply comprises incorporated thickness modulations and at least one luminescent substance that, if applicable, can be combined with further luminescent substances. The second ply can comprise no luminescent substance, the same luminescent substance as that of the first ply, a luminescent substance that differs from the first ply, or also combinations of different luminescent substances. Similar applies to any additionally present paper plies. The paper thickness variations in the first and second ply or, if applicable, also further plies, can be coordinated with each other in such a way that the plies complement each other to form a multi-ply security paper of constant thickness.

If applicable, in addition, one or more further feature substances can be incorporated into the individual plies independently of one another. The feature substances are, as described above, machine-readable substances, preferably having electrical and/or magnetic properties.

In this aspect, the present invention offers the advantage that a security paper, although it is merely provided with a luminescent substance, can be produced having a plurality of codes by simply varying the paper thickness. The number of different variation possibilities can be increased further by combining the luminescent and feature substances. The manufacture of the encoded security paper is particularly simple in that the introduction of the luminescent and, if applicable, feature substances, as well as the paper thickness modulation, occur in one work step at paper manufacture, and no additional apparatuses are required that have to be integrated into the paper machine. In this way, different currencies, denominations of a currency or also tax stamps, etc. can be economically provided with a machine-readable code.

In addition to the simple possibility of manufacturing, also the counterfeit protection can be significantly increased in that the code is designed to be invisible, i.e. is not visually perceptible, but nevertheless easily machine-measurable. Due to the luminescent and feature substances integrated into the paper volume, a subsequent change of the authenticating mark is also not possible without destroying the paper.

Further, a method for checking the authenticity of a security paper is provided. In checking the authenticity, the luminescent, electrical and/or magnetic properties of the security paper are measured with the aid of a sensor, very specific signal intensities resulting depending on the concentration of the luminescent or of the feature substance and the paper thickness. The signal intensity is influenced as follows: The higher the concentration (quantity of a substance per volume unit) of the luminescent or of the feature substance in the paper is, or the thicker the paper is at a certain location, the higher the intensity of the measurement signal is.

In a watermark, with reference to the normal paper thickness, the paper is thinner at the locations that appear brighter in transmitted light and thicker at the locations that appear darker. Consequently, the thickness modulation in the paper results in a modulation of the amount of luminescent or feature substance. Accordingly, the signal intensity varies as well. Advantageously, the measurement occurs by means of a hand sensor that responds to the different luminescent or feature substances.

Some particularly advantageous embodiments of multi-ply security papers according to the present invention are explained below by reference to the drawings, in which a depiction to scale and proportion was omitted in order to improve their clarity.

Shown are:

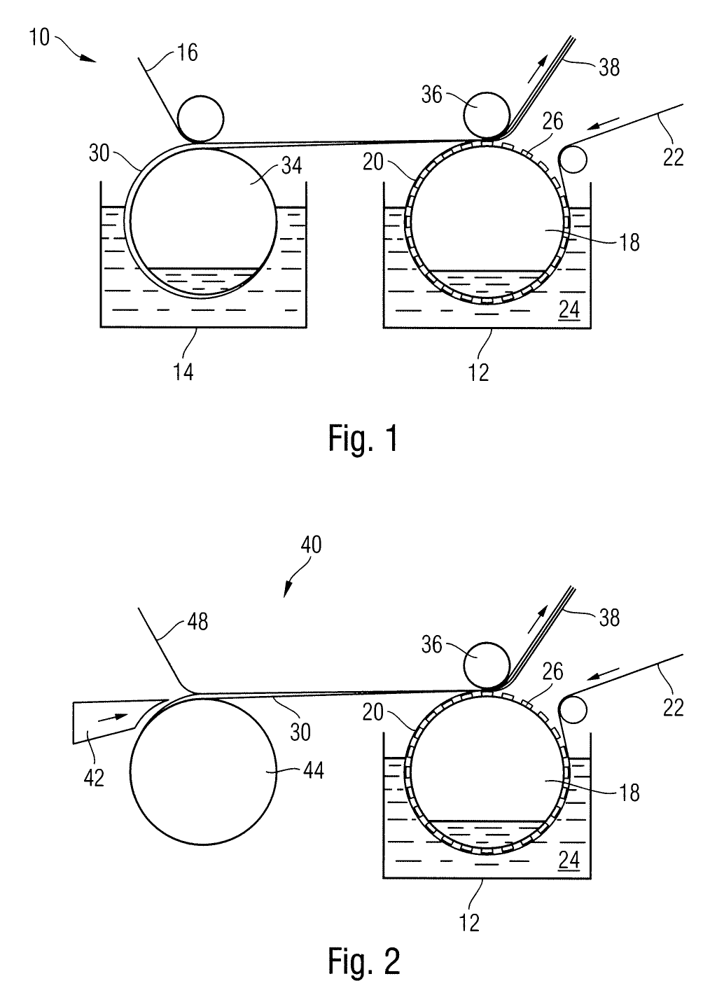

FIG. 1 a schematic diagram of a double cylinder mold paper machine for manufacturing a security paper,

FIG. 2 a paper machine having a cylinder mold paper machine and a pressure former, diagrammed schematically,

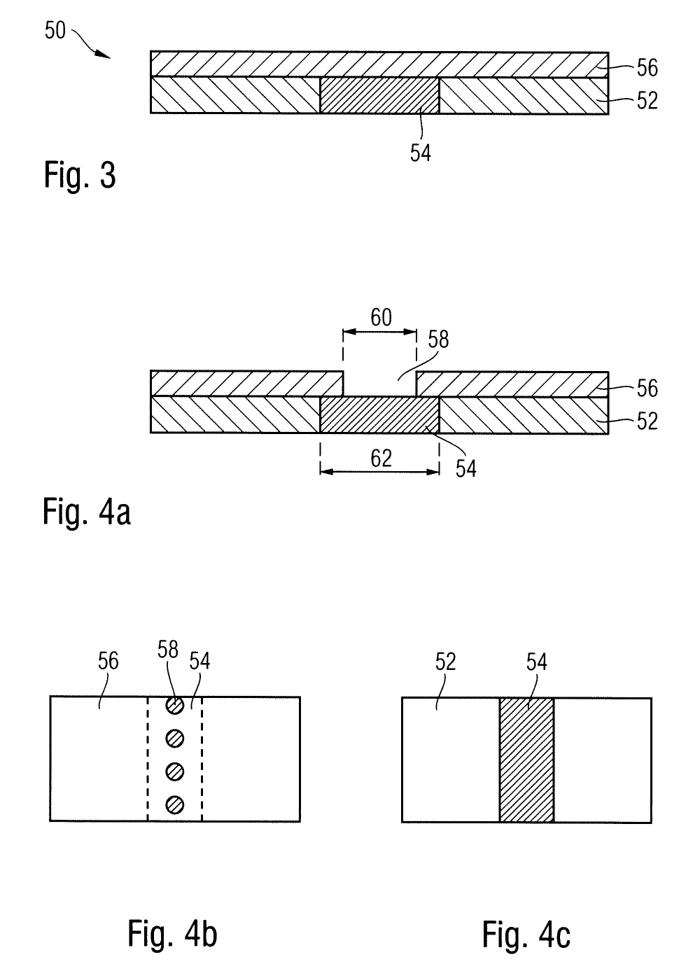

FIG. 3 the layer structure of a security paper according to an exemplary embodiment of the present invention, in cross section,

FIG. 4 in (a), the layer structure of a security paper according to another exemplary embodiment of the present invention, in cross section, and in (b) and (c), a top view of the front or reverse of the security paper,

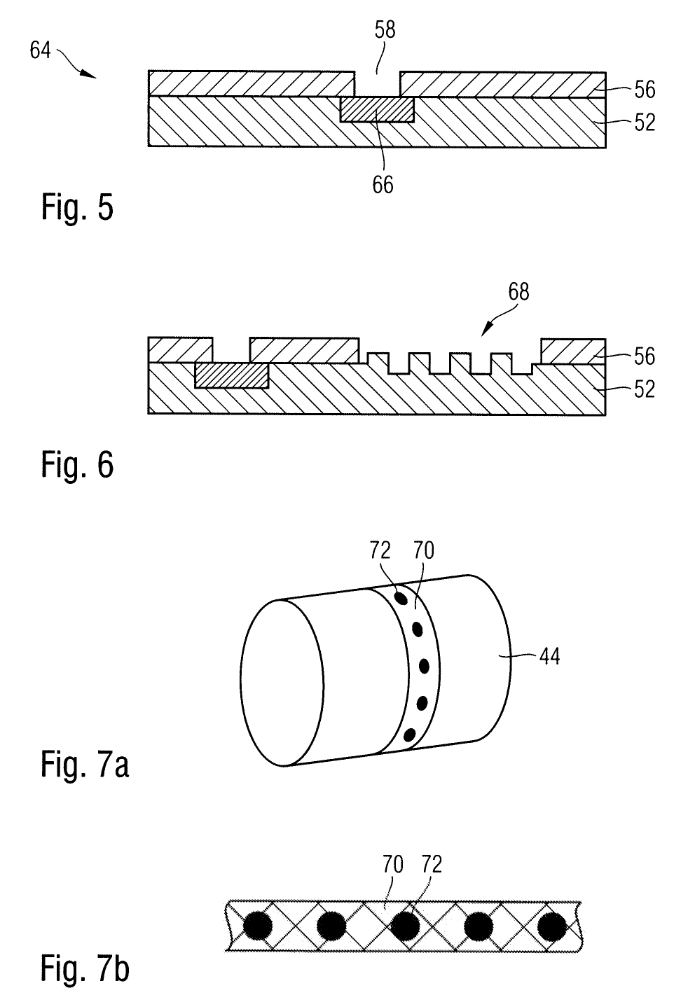

FIGS. 5 and 6 the layer structure of further security papers according to the present invention, in cross section,

FIG. 7 in (a), a cylinder mold of a pressure former having an affixed cover strip, and in (b), a section of the cover strip itself,

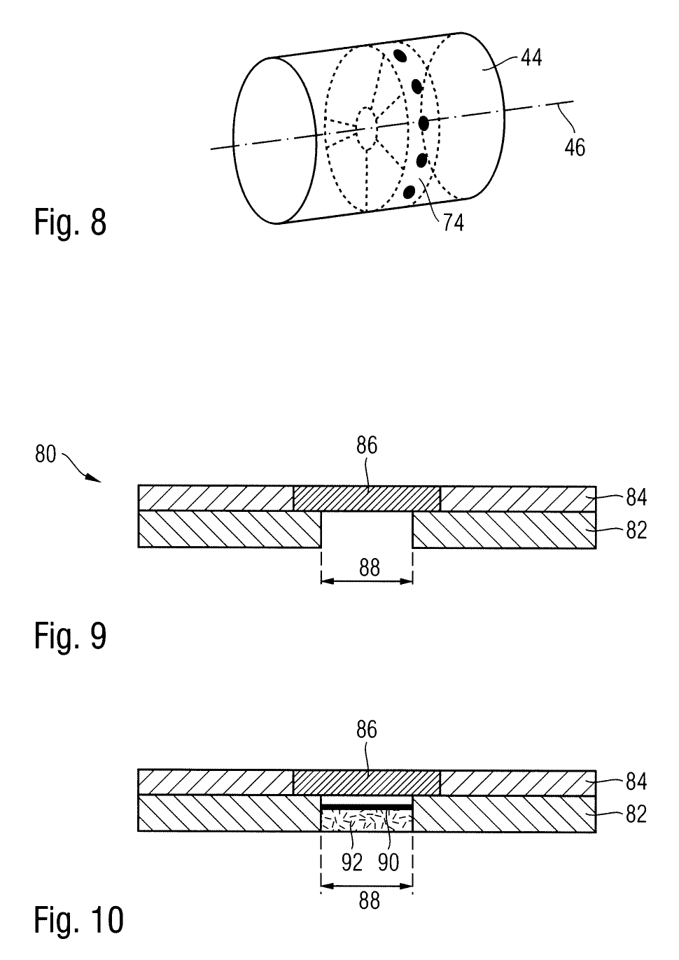

FIG. 8 a cylinder mold as in FIG. 7(a) having a cover ring running in the interior,

FIGS. 9 and 10 the layer structure of further security papers according to the present invention, in cross section,

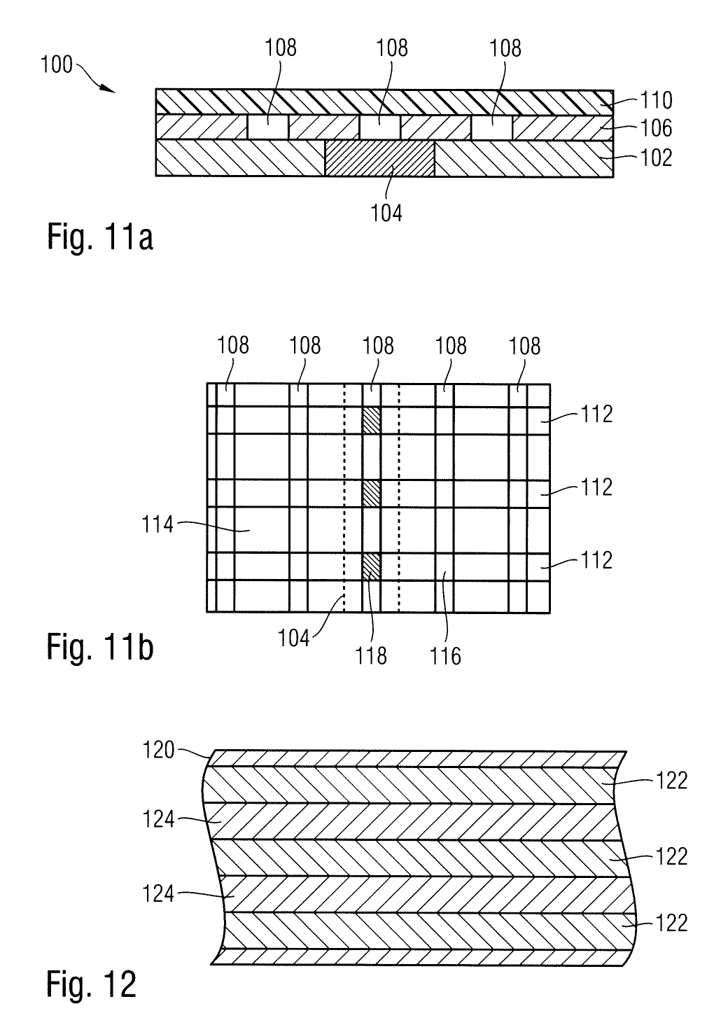

FIG. 11 a three-ply security paper according to an exemplary embodiment of the present invention, in (a), in cross section and in (b), as viewed from above,

FIG. 12 a further security paper according to the present invention, as viewed from above,

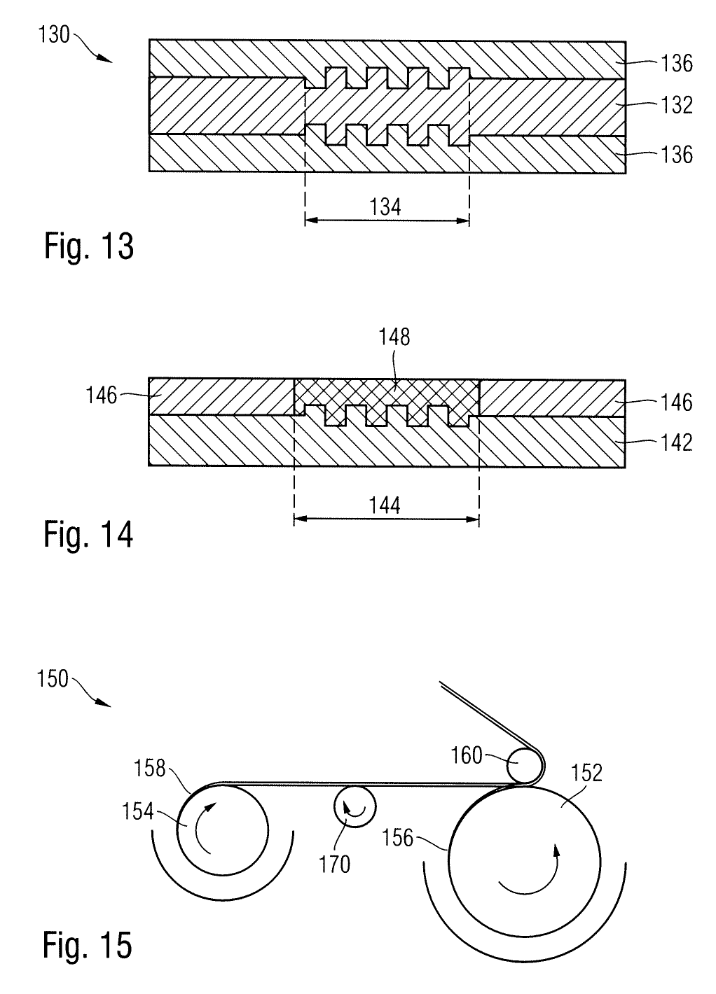

FIGS. 13 and 14 the layer structure of further security papers according to the present invention, in cross section,

FIG. 15 a schematic diagram of a double cylinder mold system having a perforated plate roll for manufacturing security papers according to the present invention,

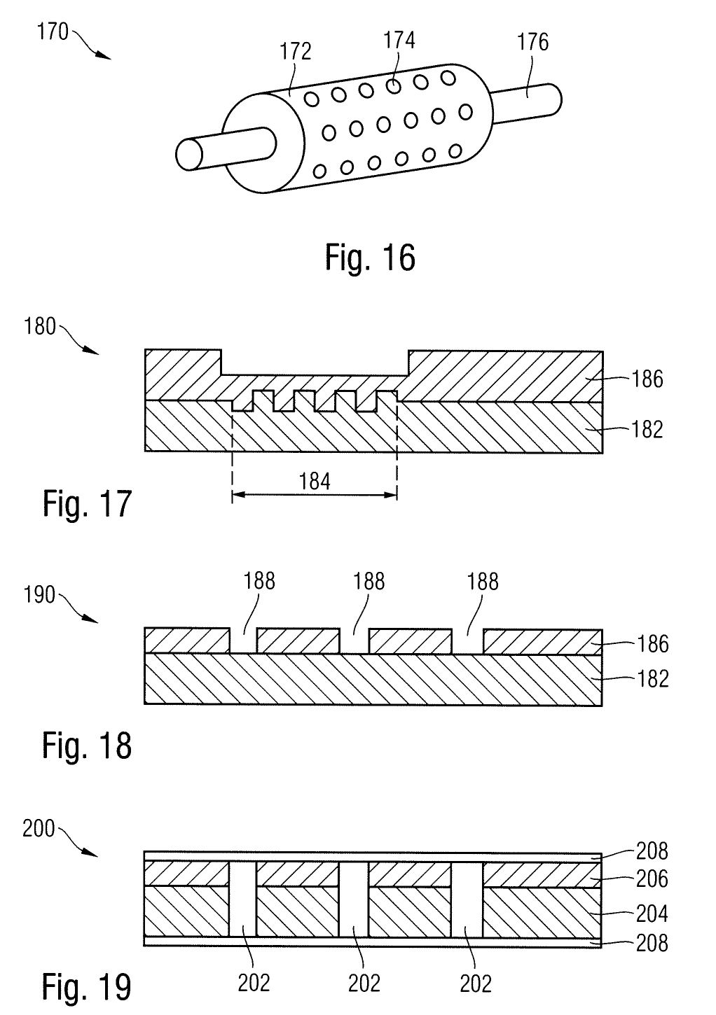

FIG. 16 the perforated plate roll of FIG. 15, separately,

FIG. 17 to 20 the layer structure of further security papers according to the present invention, in cross section,

FIGS. 21 and 22 in each, a sub-area of a paper machine for manufacturing a multi-ply security paper according to the present invention,

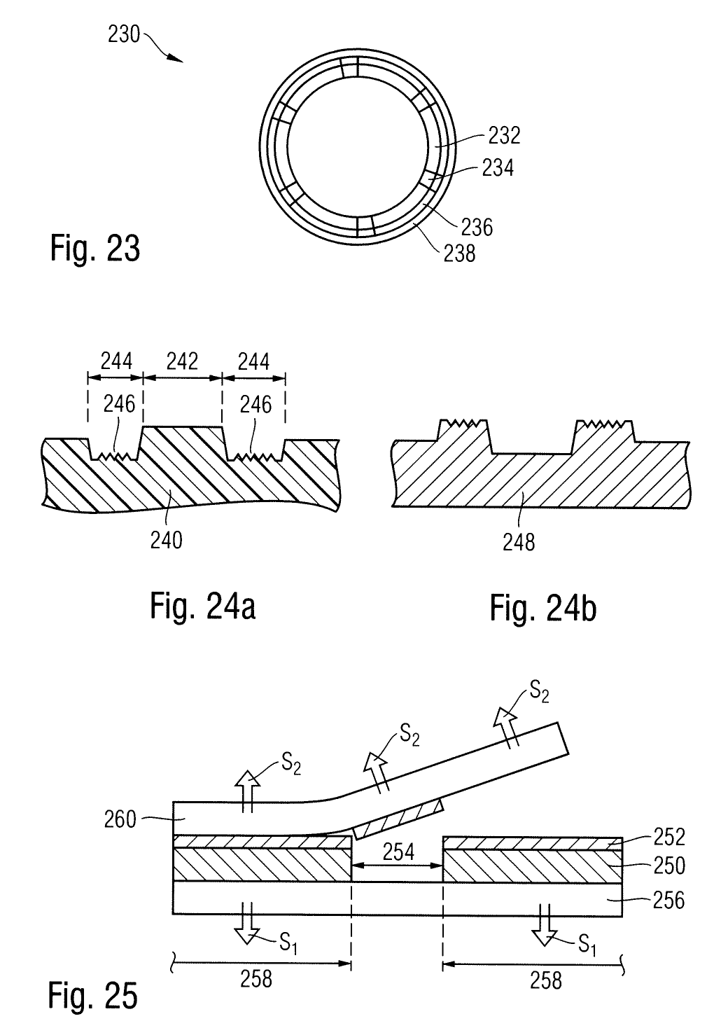

FIG. 23 the suction couch of FIG. 22, in cross section,

FIG. 24 in (a), a schematic diagram of a mold for manufacturing bar watermarks, and in (b), a cross section through the paper detached from the mold, in the watermark region,

FIG. 25 an intermediate stage in paper manufacture to illustrate a further possibility for producing a through opening in a multi-ply security paper,

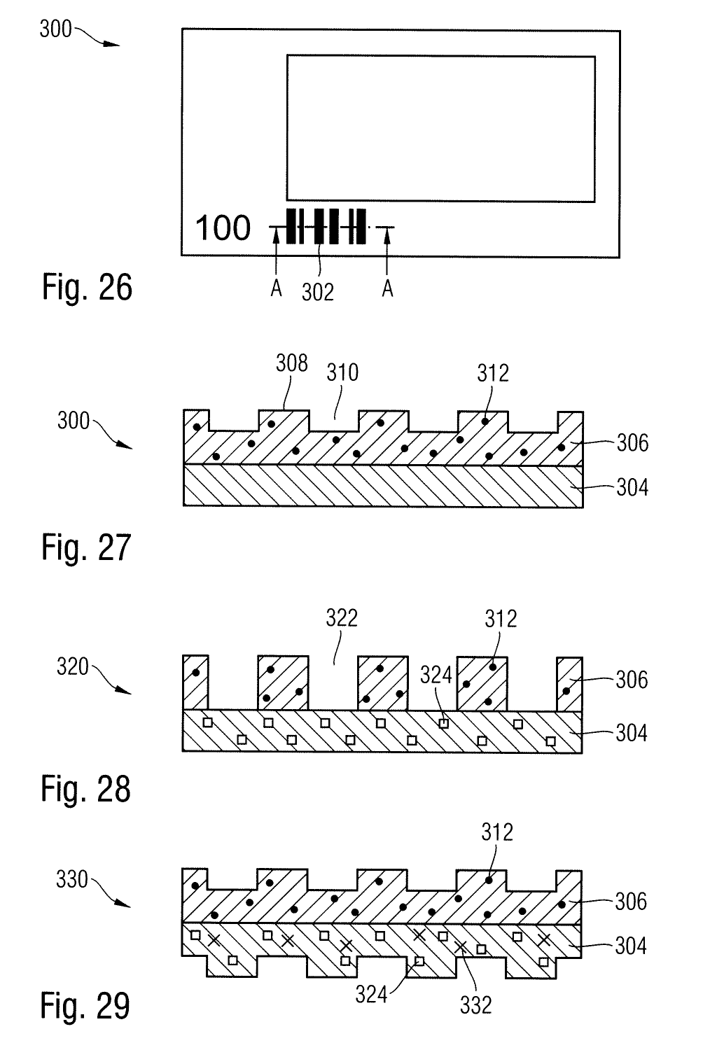

FIG. 26 a value document composed of inventive security paper according to a further exemplary embodiment of the present invention,

FIG. 27 to 29 variants of the security paper in FIG. 26, in a section along the line A-A,

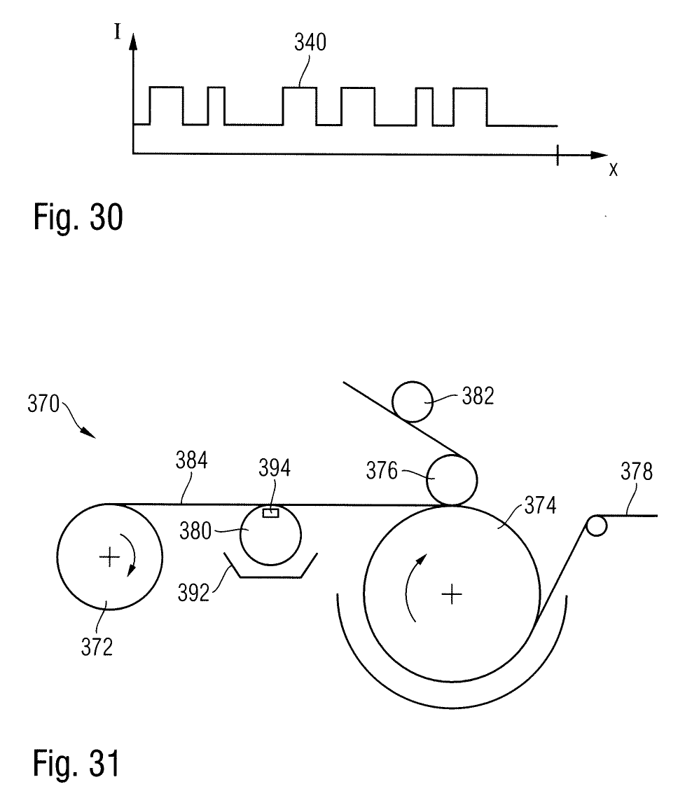

FIG. 30 a measurement signal in the authenticity check, namely the intensity I as a function of the measuring point,

FIG. 31 a schematic diagram of a paper machine having drawing-off devices according to the present invention,

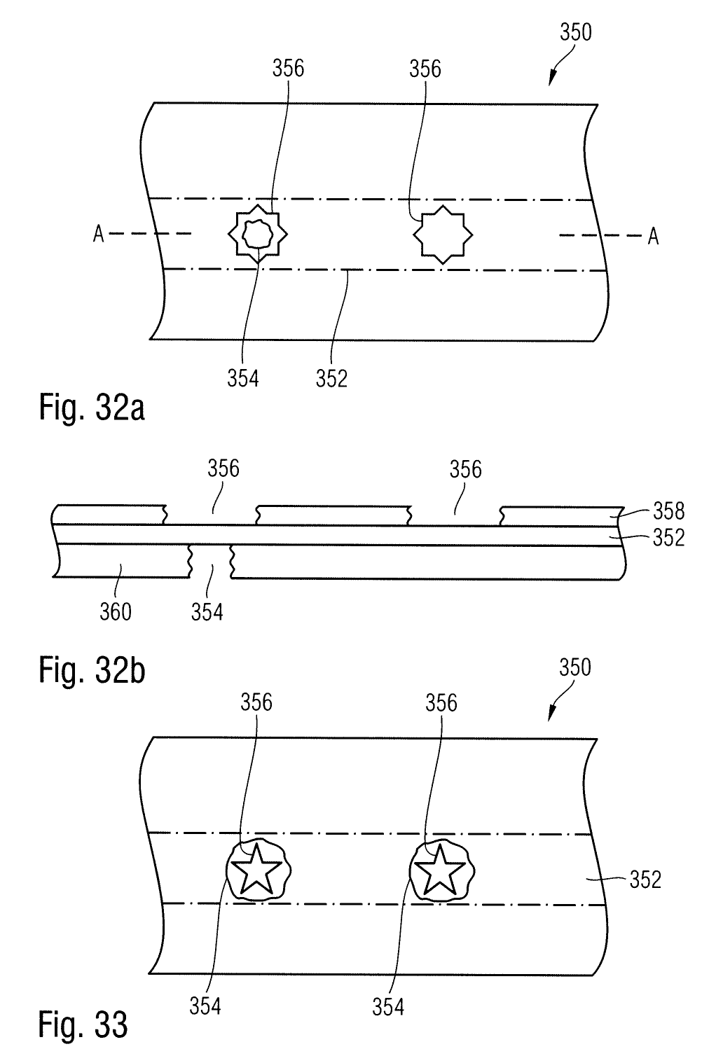

FIG. 32 a security paper according to the present invention, in (a), as viewed from above, and in (b), in cross section,

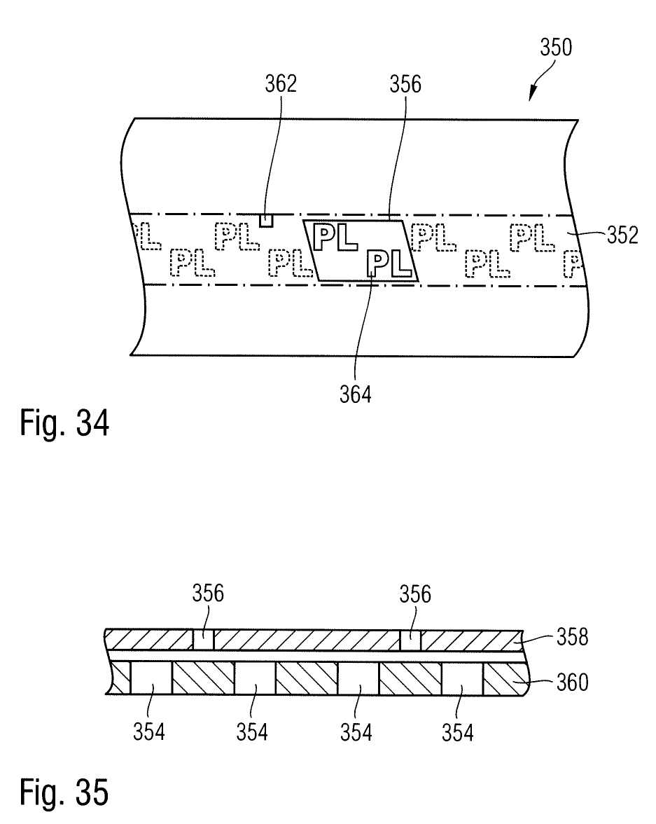

FIGS. 33 and 34 schematic diagrams of security papers according to further exemplary embodiments of the present invention, as viewed from above,

FIG. 35 a further security paper according to the present invention, in cross section,

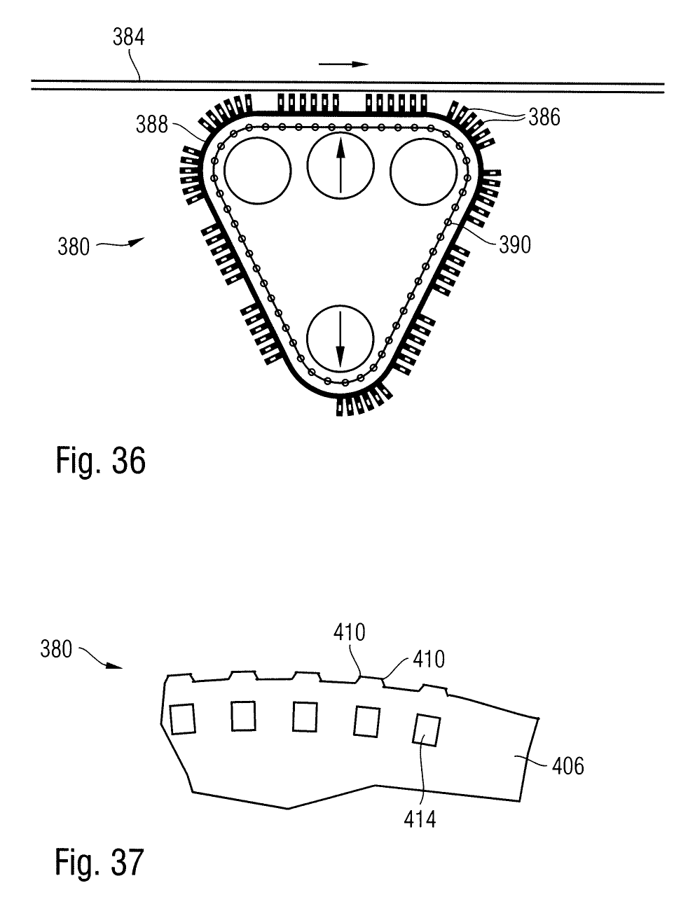

FIG. 36 an exemplary embodiment of a drawing-off device that is usable in the paper machine in FIG. 31 and that is suitable particularly for cramped space conditions,

FIG. 37 a section of a side view of a suction wheel according to a further exemplary embodiment of the present invention,

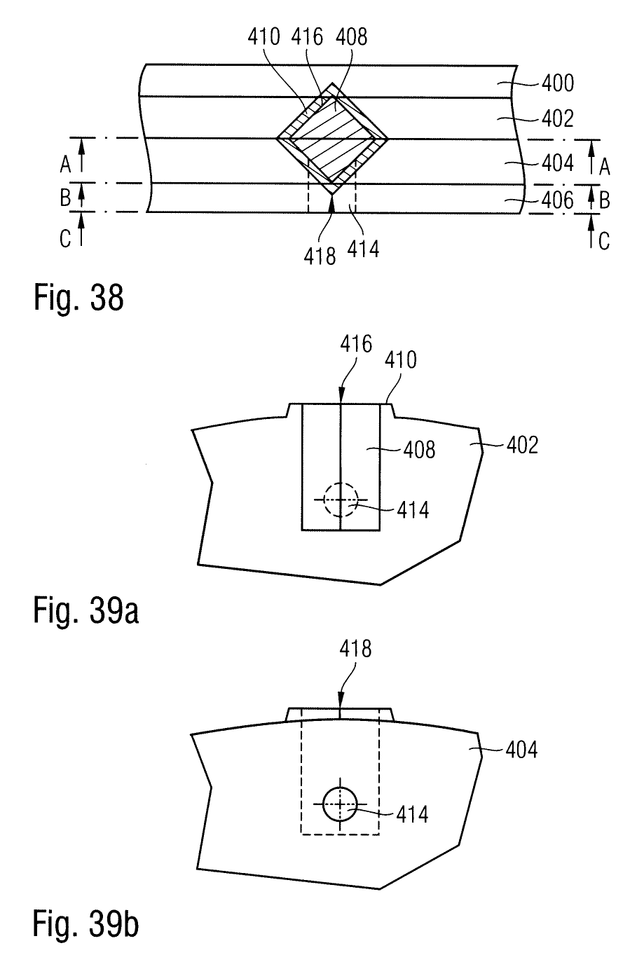

FIG. 38 a top view of a suction wheel having, compared with FIG. 37, somewhat differently designed extraction openings according to another exemplary embodiment of the present invention, and

FIG. 39 in (a) and (b), side views of the middle segments of the suction wheel in

FIG. 38, looking toward lines A-A and B-B.

FIG. 1 shows, diagrammed schematically, a double cylinder mold paper machine 10, as is used in manufacturing security paper. The paper machine 10 includes two cylinder mold paper machines 12 and 14 that are connected with each other via a pickup felt 16.

In the first paper machine 12, on a cylinder mold 18, a paper web 20 is formed in which a security element, here a wide, liquid-impermeable security band 22, is embedded. For this, the security band 22 runs onto protuberances 26 of the cylinder mold 18 prior to immersion in the paper pulp 24 of the paper machine. The security band 22 can exhibit, for example, a width of 20 mm or even 30 mm. Due to its large width, no sheet formation takes place in the regions in which the liquid-impermeable security band 22 lies on the protuberances 26 of the first paper mold 18, such that the security band 22 divides the first paper web 20 into two parts. Here, a characteristic deckle edge forms at the edges of the security band 22. For better anchoring of the security band 22, liquid- or even fiber-permeable regions can be provided in its border regions.

In the second paper machine 14, a second, homogeneous paper web 30 is manufactured in parallel, removed from the cylinder mold 34 by means of the pickup felt 16, and guided to the first paper machine 12 where, in the region of the pressure roller 36, it is joined with the first paper web 20. Here, the first paper web 20 with the included security band 22 is contiguously covered by the homogeneous second paper web 30. The joined paper webs 38 are then conveyed to further processing stations, such as calendering, sizing and the like.

As depicted in FIG. 2, the second paper web 30 can also be produced with a pressure former 40 in which the paper pulp is jetted onto the surface of a cylinder mold 44 with a headbox jet 42. Particularly thin paper plies, for example having a grammage of 15 to 25 g/m², can be produced with such a pressure former.

It is understood that, with the paper machines 12, 14, 40 shown, similarly also three or more paper webs can be produced and merged.

A multi-ply security paper 50, such as can be manufactured with one of the paper machines in FIGS. 1 and 2, is shown in FIG. 3, in cross section. The security paper 50 includes a first paper ply 52 that is divided by a wide security band 54, and a thinner second paper ply 56 that covers one side of the first paper ply 52. In an advantageous variant, the first paper ply 52 is provided with a watermark and the security band 54 exhibits a hologram or a hologram-like diffraction pattern. Here, the thin second paper ply 56 serves as reinforcement in the region of the security band 54. As an alternative to this, in the first paper ply, longitudinally of the security thread embedded in the paper, holes can be present that are wider than the security band. The second paper ply covers the first paper ply.

To manufacture the multi-ply security paper in FIG. 3, also the procedure may be used that, first, paper ply 52 having a strip-shaped gap and the paper ply 56 are manufactured and merged, and then the security band 54 is inserted into the strip-shaped gap.

In the exemplary embodiment in FIG. 4, into the second paper ply 56 is introduced an interruption 58 whose width or diameter 60 is less than the width 62 of the security band 54. The interruption 58 can be designed for example, in the form of a strip-shaped opening having width 60, but also in the form of individual openings of any shape. The measurement 60 then corresponds to the dimension of the openings perpendicular to the running direction of the security band 54. For an embodiment of the interruption 58 as a linear hole array, FIG. 4(a) shows the security paper in cross section, and FIGS. 4(b) and 4(c), top views of the front and reverse of the security paper.

The further exemplary embodiment in FIG. 5 shows a security paper 64 in which is embedded, in contrast to the exemplary embodiment in FIG. 4, not a wide security band, but rather a narrow security thread 66 having a width of 1.5 mm or less. In such security threads, the back-side sheet formation is not suppressed in the first paper machine 12, such that the security thread 66 does not divide the first paper ply 52, but rather is embedded in it and is freely accessible only from one side.

In both embodiment variants, the first paper ply 52 can include a watermark, additional openings or other authenticating marks. If the first paper ply 52 includes, as shown in FIG. 6, a watermark 68, then the second paper ply 56 is advantageously interrupted in the region of the watermark 68 to increase the visibility of the watermark. Instead of the security thread, also a wide security band can, of course, be introduced into the security paper in FIG. 6.

To produce the interruption 58 in the second paper ply 56, the pores of the cylinder mold of the second sheet forming unit, for example of the cylinder mold 44 of the pressure former 40, are closed in sub-areas. As shown in FIGS. 7(a) and (b), this can occur through a mesh strip 70 affixed on the shell of the cylinder mold 44 and having covered regions 72 in the form of the desired openings. To produce a strip-shaped interruption, the cover strip 70 can also be designed to be completely impermeable.

Alternatively, the holes of the mold surface can also be closed at the desired sites with a lacquer overprint. A lacquer layer applied in screen printing can be washed out again with no problem after the job is completed and the mold provided with a new lacquer layer for the next job.

According to the further variant depicted in FIG. 8 is provided in the interior of the cylinder mold 44 a cover ring 74, running on the mold axis 46 and having closed and perforated sub-areas, that pushes radially outward against the mold shell and thus prevents sheet formation in the closed sub-areas.

In all of the methods described, in the second paper ply 56 are produced interruptions 58 that exhibit a deckle edge that is not imitable by cutting or punching.

According to a further variant of the manufacturing method, the security thread or the security band runs in at the second sheet forming unit, for example the pressure former 40. Here, the cylinder mold of the second sheet forming unit can be masked in the region of the security thread or security band, or the incoming security element itself can cover the cylinder mold appropriately. In this variant, the thicker first paper web can be formed with or without a through opening in the region of the security element.

An exemplary embodiment of a security paper 80 produced according to this manufacturing variant is depicted in FIG. 9. The first and second paper ply 82 and 84 are depicted with different hatchings for illustration only, they appear as a uniform paper ply in the finished security paper 80. The security element 86 disposed in the gap of the second paper ply 84 is visible from both sides of the security paper due to the interruption 88 in the first paper ply 82 and can, for example, exhibit optically variable elements on both sides. If necessary, the security element 86 can be fixed in the gap of the second paper ply with an adhesive. The strip-shaped interruption or the other openings produced in any shape can be filled with polyurethane following drying of the security paper.

A modification of the multi-ply security paper in FIG. 9, in which the interruption can be exposed at any time after manufacture, is shown in FIG. 10. As in the exemplary embodiment in FIG. 9, in the second paper ply 84 of the security paper, a security element 86 dividing this paper ply is produced, and in the first paper ply 82, a strip-shaped interruption 88. In addition, into the strip-shaped interruption 88 was additionally introduced at paper manufacture a release strip 90 on whose reverse a thin paper layer 92 formed. On the finished security paper, the release strip 90 can be removed together with the paper deposit 92 like a tear strip and leaves behind a subsequently introduced opening in the first paper ply 82 that enables the view of the security element 86.

It is understood that also more than two paper plies can be combined to form a multi-ply security paper. For example, a relatively thick paper ply produced on a direct-current cylinder mold and into which watermarks, openings or a security element can be introduced can be combined with two or more thinner paper plies that are formed on further sheet forming units, especially the above-described pressure formers. These paper plies can be produced with separate sheet forming units or also manufactured by separate headboxes on the same short former.

Some particularly advantageous exemplary embodiments of such multi-ply security papers will now be described with reference to FIGS. 11 to 14.

FIG. 11 shows, in (a), a three-ply security paper 100, in cross section, and in (b), as viewed from above. Into a first, thick paper ply 102 produced on a direct-current cylinder mold, a security strip or a wide security band 104 is introduced is the manner described above. Two heterochromatic thin paper plies 106 and 110 are applied to the first paper ply 102 with the aid of two pressure formers.

Strip-shaped interruptions are introduced into the paper plies 106 and 110 by masking the cylinder molds of the respective pressure formers. Here, the cylinder mold of the first pressure former is provided with vertical adhesive strips to produce strip-shaped interruptions 108 in the second paper ply 106. The cylinder mold of the second pressure former is masked with horizontal strips, forming in the third paper ply 110 strip-shaped interruptions 112 that stand vertical to the strips 108 of the second paper ply 106. Here, the terms “horizontal” and “vertical” for the adhesive strips refer to the axis of the respective pressure former mold.

Due to the interruption strips 108 and 112 that are vertical to each other, a checkerboard-like pattern is created in the security paper 100, as well as views to the surface of the security element 104 in the intersections. In the exemplary embodiment, the second paper ply 106 is colored reddish, while the first and third paper ply 104 and 110 are white.

In the regions 114 in which neither the second nor the third paper ply exhibits an interruption, the reddish coloration of the second paper ply 106 shows through the thin third paper ply 110 and produces a slightly reddish appearance. In the horizontal interruptions 112 in the third paper ply, the view of the second paper ply 106 is enabled such that a stronger red coloration shows up there. At the sites having an interruption only in the second paper ply 106, the red coloration is missing, such that these sites produce a vertical white strip pattern against a reddish background. Lastly, the surface of the first paper ply 102 is exposed in the intersection regions 116 of the two interruption patterns. In the interruption strip 108 that just lies over the security band 104, the view of the surface of the security band 104 is enabled in the intersection regions 118 such that further authenticity features can be perceptible there.

In FIG. 12, a security paper according to another variant is shown as viewed from above. In this variant, a first pressure former produces a paper ply 122 having strip-shaped interruptions, and a second pressure former produces a paper ply 124 that is complementary thereto, likewise having strip-shaped interruptions, such that the two strip-shaped paper plies 122, 124 complement each other to form a contiguous paper ply 120. To produce a visually or machine-verifiable contrast, the paper plies 122, 124 are especially formed from different fibers, for example from fibers of different colors or different lengths, or from fibers having different feature additives. The paper ply 120 can also be combined with a third, homogeneous paper ply or with further layers composed of paper or plastic.

A further exemplary embodiment of the present invention is depicted in FIG. 13. To combine particularly high tensile strength with a well perceptible and clear watermark, paper plies of differing thickness and having different fiber length are used in the security paper 130. The middle paper ply 132 is produced with short fibers on a direct-current cylinder mold. This paper ply 132 takes up about ⅔ of the total thickness of the security paper 130. It is provided in a sub-area with a watermark 134 that, due to the short fibers used, is sharply contoured and appears having a pronounced watermark effect.

On its top and bottom, the middle paper ply 132 is joined with two thinner paper plies 136 that are produced, for example, with a pressure former. For its manufacture, longer fibers are used that lend the multi-ply structure 130 a particularly high tensile strength.

A further variant of the present invention is depicted in FIG. 14. In this variant, a thicker paper ply 142 of the security paper 140 is provided with a watermark 144. To the surface of the first paper ply 142 are applied two pressure former plies 146 and 148 that are complementary to each other, the first pressure-former ply 146 exhibiting in the region of the watermark 144 a strip-shaped interruption in which the second pressure-former ply 148 comes to lie. The second pressure-former ply 148 is formed with transparent fibers, in the exemplary embodiment with suitable polymer fibers, through which the watermark region 144 is simultaneously well protected and clearly visible.

One possibility for manufacturing security paper via a double cylinder mold system with high traveling speeds will now be explained with reference to FIGS. 15 to 20. For this, FIG. 15 shows schematically a double cylinder mold system 150, configured similarly to FIG. 1, having a first cylinder mold 152 and a second cylinder mold 154 for manufacturing a first and second paper web 156 and 158 that are merged and, in the region of the pressure roller 160, joined together. The first cylinder mold 152 is normally designed individually in each case for the manufacture of different security papers.

If the second paper web 158 is in the grammage range of about 10 to 45 g/m², it has proven to be particularly effective when the second paper web 158 is produced homogeneously, that is, having the nature of vellum, since then the second cylinder mold 154 can be designed homogeneously. In particular, in this case, the need to adapt the second cylinder mold 154 to the individual design of the first cylinder mold 152 in each case is eliminated. In this way, an optimization of the technical structure is achieved for a stable and maintenance-free manufacture of precisely this vellum paper of low grammage. However, a project-individual design of the second cylinder mold 154 is then possible only with considerable outlay or not at all.

In some cases, however, an individualization of the second paper web is also desired. If, for example, in addition to an opening in the first cylinder mold side, also an opening of the paper to the second cylinder mold side is to occur, and this opening is to take place in the wet end, then generally, the second cylinder mold 154 must be individualized. Possibilities were already specified above to achieve this individualization through partial closure of the holes of the second cylinder mold. These possibilities lend themselves especially when the second cylinder mold opening in the paper web running direction can lie in a different place with no registration whatsoever on any document manufactured.

If, in contrast, the second cylinder mold opening is to lie at certain predefined locations in the manufactured documents, then, in the above-described approach, the circumference of the second cylinder mold must be adapted to the first cylinder mold and operated fittingly for the first cylinder mold in register and rotational speed. This entails considerable outlay in equipping the paper machines as well as in mold manufacture and mold change.

The manufacturing route described below is thus based on the idea of leaving the highly efficient operation mode of the second cylinder mold in the grammage range 10 to 45 g/m² and to achieve the individualization, not through individualization of the second cylinder mold 154, but rather through individualization of the produced vellum paper web 158. For this, in the exemplary embodiment, a perforated plate roll 170 is provided that is depicted again separately in FIG. 16.

The perforated plate roll 170 exhibits, in paper web width, a metal drum 172 that exhibits bores 174 in a desired arrangement and size and that, further, is provided with a vacuum-suction connection 176. The perforated plate roll 170 is pivot mounted and disposed between the second cylinder mold 154 and the first cylinder mold 152 at a small distance from the pickup felt on which the second paper web 158 is guided to the pressure roller 160. The circumference of the metal drum 172 corresponds to the length of a printing sheet and is thus in register with the first cylinder mold 152. Furthermore, the perforated plate roll 170 is driven in register with the first cylinder mold 152 to maintain the register accuracy.

Through the vacuum-suction connection 176 and the bores 174, paper fibers can be drawn off of the second paper web 158 such that new effects can be realized in register with the first paper web 154.

For example, the exemplary embodiment in FIG. 17 shows a security paper 180 having a first paper ply 182 having a watermark 184 and a second paper ply 186 applied to the first paper ply. Here, with the perforated plate roll 170, in the wet end of the paper machine 150, paper fibers were removed from the second paper ply 186 in register with the watermark 184 such that the watermark 184 is clearly perceptible. For this manufacture of the watermark 184 it is not necessary to remove all paper fibers in the watermark region, but rather, partially drawing off fibers from the second paper web 156 is sufficient, as depicted in FIG. 17.

Also a selective complete removal of the fibers of the second paper ply 186 may be used, as shown for the security paper 190 in FIG. 18. In the drawn-off regions 188, the first paper ply 182 is completely exposed.

Above all, together with openings in the first paper web, the partial or complete removal of the paper fibers of the second paper web can be combined with the introduction of different security elements, such as swing security threads or two-sided security threads, or with two-sided security elements introduced true to side. Here, the security element can exhibit in the paper web running direction an element that is in register with the document to be manufactured. The security element is then introduced in longitudinal register, which, for security threads, can be realized for example with a direct thread drive.

FIG. 19 shows a security paper 200 having multiple see-through openings 202 that are formed by register-accurately disposed openings in the first and second paper ply 204 or 206. After paper manufacture, the see-through openings 202 can be closed from one or from both sides with a transparent or translucent foil 208.

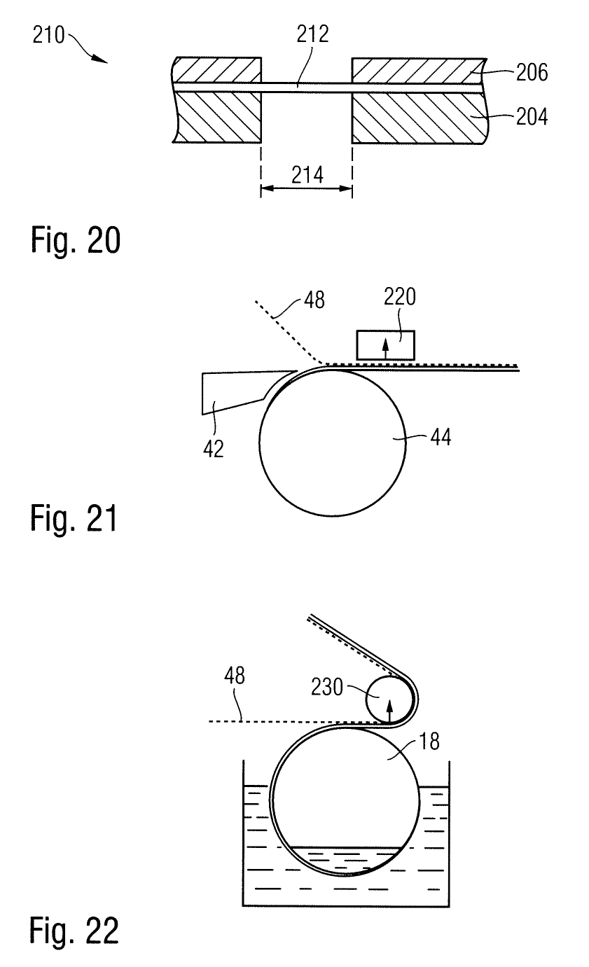

In the modification in FIG. 20, in the manufacture of the first paper web, the two-sided security thread 212 is introduced such that it lies completely on the first-felt side. If the perforated plate roll 170 is operated appropriately, the see-through opening 214 formed by the register-accurate openings in the first and second paper ply is then closed from the inside by the security thread 212. The top-side and bottom-side security features of the security thread 212 are then each perceptible from the two opposing sides of the security paper 210.

The see-through opening(s) in FIG. 19 or 20 can also be designed having a foil thread element that is introduced true to side and/or in longitudinal register with the document to be manufactured.

The perforated plate roll can also be disposed only after the merging point of the first and second paper web and there draw off the paper fibers of the second, thinner web through openings in the first paper web.

Especially in the manufacture of comparatively thin paper webs, such as are often used for one of the paper plies of a multi-ply security paper, there is a risk that holes will be torn in the finished paper web upon removal of the web from the cylinder mold. This can be remedied, for example, by a suction couch disposed over the carrier mold.

For this, FIG. 21 shows a sub-area of a paper machine for manufacturing multi-ply security paper, such as the paper machine shown in FIG. 2, for example. Here, in addition to the elements already described in connection with FIG. 2, a suction couch 220 is disposed over the carrier mold 48 to cleanly lift the formed sheet from the cylinder mold 44. For this, the suction couch 220 produces a negative pressure that, in the exemplary embodiment, is 0.2 bar greater than the negative pressure in the interior of the cylinder mold 44. In this way, the sheet is pulled by the suction couch 220 up onto the carrier mold 48 and removed from the cylinder mold 44 cleanly and without tears. Such a suction couch can advantageously also be used in connection with a direct-current cylinder mold, as illustrated by FIG. 22. FIG. 22 shows a sub-area of a paper machine, for manufacturing multi-ply security paper, in which a suction couch 230 is floatingly disposed at a small distance above the cylinder mold 18. Due to the floating arrangement, the cylinder mold 18 and the watermark types are prevented from damage. Since the suction couch 230 does not rest on the cylinder mold, it must additionally be driven by an independent drive train, a register-accurate synchronism with the cylinder mold 18 being advantageous.

For a paper thickness of about 0.7 mm, the distance of the suction couch 230 from the cylinder mold is preferably less than 1 mm. The couch 230 is thus raised in watermark regions of the paper, in which the paper thickness can measure up to 1.2 mm, such that, also in these regions, it does not touch the mold. Such a suction couch 230 can advantageously be used, for example, in the manufacture of bar watermarks in security paper. Through the support of the removal of the paper web, bars having high brightness constancy are achieved.

In the exemplary embodiment, the suction couch 230 comprises, as depicted in cross section in FIG. 23, a perforated bronze shell 232 of a thickness of about 2 cm. The openings 234 in the bronze shell exhibit a diameter of about 6 mm. On its outer side, the bronze shell 232 is surrounded by a perforated rubber blanket 236 and a felt 238 of defined permeability.

The uniformity of bar watermarks in a multi-ply security paper can also be improved with the aid of the mold 240 shown in FIG. 24(a). To produce a bar watermark, the mold 240 according to the present invention exhibits an appropriately arranged sequence of elevations 242 and depressions 244. Into the depressions 244 of the mold, so the sites of greater paper thickness, are milled grooves 246 that facilitate the paper removal from the mold 240. It has been shown that the grooves 244 lead to a more even deposit of paper pulp on the mold, improved take-up, and thus to a more uniform brightness of the produced bar watermarks in the uplifted paper web 248 (FIG. 24(b)).

As already mentioned above, it can be desired to form a through opening in a multi-ply security paper. For this, register-accurate openings can be produced in the paper plies, for instance with the aid of the perforated plate roll described above. Another possibility will now be explained with reference to the depiction in FIG. 25.

FIG. 25 shows an intermediate stage in paper manufacturing, in which a first and second paper web 250 and 252 are already merged and joined together. An opening 254 is introduced into the first, thicker paper web 250, and the second paper web 252 is formed homogeneously and without individualization. The two paper webs 250, 252 run on a first felt 256 that is acted on with a suction pressure S₁ in the regions 258 outside the opening 254. A suction pressure S₂ is applied upward on a second felt 260 resting on the second paper web 252. Here, the suction pressure S₁ is greater than the suction pressure S₂ such that the second paper web 252 cannot be lifted up from the second felt 260 in the regions 258.

In the region of the opening 254, no suction pressure S₁ is applied downward, for example through pulsed suction. The suction pressure S₂ thus prevails there and the second paper web 252 is lifted up with the felt such that a through opening is created in the multi-ply security paper 250, 252. If applicable, in the region of the opening 254, an air jet can also be blown against the first felt 256 to facilitate the lifting up of the second paper web. Also other measures can be provided, such as a counter pressure produced by a laser beam or a water jet, or special geometric hole shapes that facilitate the removal of the second paper web in the opening region 254.

As already mentioned, there is a further possibility to integrate authenticity features into multi-ply security paper, in the addition of feature substances, such as luminescent substances. Here, embodiments have proven to be particularly advantageous in which, in at least one of the paper layers, a luminescent substance is distributed homogeneously in the volume of the paper layer, and this paper layer exhibits different paper thicknesses at least in a sub-area, as clarified below through a few exemplary embodiments.

For this, FIG. 26 shows an inventive value document 300, here a banknote, in which a bar watermark 302 is incorporated in the form of a barcode. FIG. 27 shows the value document 300 in the section along the line A-A and renders the layer structure of the security paper used. Accordingly, the security paper exhibits a homogeneous first paper ply 304 and, joined therewith, a second paper ply 306 having a step profile.

The elevations 308 of the second paper ply, i.e. the regions having thicker paper, appear darker in transmitted light, and the depressions 310, i.e. the regions having thinner paper, appear lighter in transmitted light. As the feature substance, a luminescent substance 312 is homogeneously distributed in the second paper ply 306.

This variant of the security paper can be manufactured with different methods. For one, a barcode can be imprinted in the second paper web in which the luminescent substance was homogeneously incorporated, for another, a watermark in the form of a barcode can be introduced into the second paper web during paper web formation on the cylinder mold. Combinations of luminescent substances can, of course, also be used. Furthermore, a feature substance or also a combination of feature substances of the kind described above can be introduced into the second paper web.

FIG. 28 shows the structure of a value document according to a further exemplary embodiment of the present invention, in cross section. Viewed from above, the value document 320 displays the same appearance as the value document depicted in FIG. 26, but here, the second paper ply 306 exhibits through openings 322, and the first paper ply likewise includes a luminescent substance 324 that can especially differ from the luminescent substance 312. The first and/or second paper ply can also comprise one or more further feature substances of the kind described above. For example, the first ply can include a luminescent substance and the second ply a feature substance.

The manufacture of this inventive variant can be carried out in accordance with the manufacture for security paper having window threads, as specified above. According to this principle, two sheets, a top and a bottom sheet, are formed and merged, windows being inserted into the top sheet, and the bottom sheet being manufactured contiguously. The desired luminescent and feature substances are incorporated into the sheets at manufacture of the top and bottom sheets. Alternatively, the windows in the top sheet can also be produced after its manufacture by punching, cutting or the like.

FIG. 29 shows a two-ply structure of an inventive value document 330, as results when cut along A-A in FIG. 26. In this exemplary embodiment, both paper plies exhibit bar watermarks. The second paper ply 306 includes a luminescent substance 312, and the first paper ply 304 includes a luminescent substance 324 that differs from 312 and, moreover, a feature substance 332. Furthermore, it is possible that further luminescent substances are present in the first and/or second ply, independently of each other, and, if applicable, one or more feature substances are incorporated in the first and/or second ply, independently of each other. In general, the bars of the different plies can be congruent, or they can also be staggered. In a further embodiment, the thickness modulations in both plies can be realized by means of windows.

FIG. 30 shows a measurement signal 340 as results in the authenticity check of an inventive value document 300 having bar watermark 302. The intensities I of the measurement signal 340 are plotted on the ordinate as a function of the measurement position x, i.e. the position of the sensor above the value document. Here, the emission intensity of the luminescent substance 312 is measured. In regions having thicker paper, the signal intensity is greater than in regions having thinner paper since, depending on the paper ply thickness, more or, as the case may be, less luminescent or feature substance is located under the sensor. If the sensor is guided transversely over the bar watermark 302, a higher intensity is measured in the region of the thicker paper than in the region of the thinner paper, and a kind of barcode is thus measured that is rendered by the measurement signal 340.

If the value document or the value document ply to be checked exhibits windows without luminescent substance 312, then the measured intensity of the luminescent substance drops to zero. The authenticity check for value documents 320 or 330 having different luminescent substances occurs similarly, whereby, if applicable, filters are used that transmit the radiation of only one of the luminescent substances.

A further variant of the present invention will now be explained with reference to FIGS. 31 to 39. First, the exemplary embodiment in FIG. 31 shows a paper machine 370 in which a first paper ply is produced with a countercurrent cylinder mold 374 and a second paper ply with a pressure former 372. Even if, in the following, the first paper ply is always referred to as the countercurrent-cylinder-mold ply, it is understood that the first paper ply in other embodiments can be produced with a direct-current mold without departing from the context of the present invention.

The two paper plies are merged in the region of the pickup roll 376 and couched together. A security thread 378 fed in at the countercurrent cylinder mold 374, or a security band, is introduced between the paper plies. Openings can be introduced into the second paper ply (pressure-former ply) 384 by means of a first drawing-off device 380 disposed between the pressure former 372 and the countercurrent cylinder mold 374. If desired, openings can also be introduced into the first paper ply (countercurrent-cylinder-mold ply) with the aid of an optional second drawing-off device 382 that is disposed after the merging point of the two paper plies.

FIG. 32 shows a section of an inventive two-ply security paper 350, as viewed from above, as can be manufactured with a paper machine 370 of the kind shown in FIG. 31. In the first paper web 360 is located a circular hole 354 that preferably was produced with papermaking technology by e-types applied to a cylinder mold. In the second paper ply 358, which was preferably produced by means of a pressure former, are located star-shaped openings 356. In the exemplary embodiment, these openings were produced by means of a perforated suction roll 380 that removed the paper fibers, still in the wet state, from this second paper web. Here, the shapes of the two openings 354 and 356 can be designed arbitrarily. Also the orientation of the openings to each other and their size can be controlled according to the requirements. For example, the two openings can come to lie on top of one another such that a see-through window is created. But they can, of course, also be disposed next to each other. Of course, the openings can also be, relative to each other, larger or smaller or the same size. In addition, as shown in this exemplary embodiment, a band-shaped security element 352, for example a wide security thread, can be embedded between the paper webs in the region of the openings. Here, the band-shaped security element 352 is concealed by the first and second paper ply and is visible merely at the openings 354 and 356 when viewed from above. FIG. 32(b) shows the cross section of the security paper along the line A-A. The band-shaped security element 352 is covered by the second paper ply 358 as well as by the first paper ply 360 and is accessible at the openings 354 and 356. Here, the size of the openings can correspond to the width of the security band. However, it is also absolutely possible that one or both openings is/are wider or narrower than the band-shaped security element.

If the two paper plies are a pressure-former ply 358 and a countercurrent-cylinder-mold ply 360 between which a security thread 352 is embedded, then, due to the different relative sizes of the openings in the pressure-form ply and the countercurrent-cylinder-mold ply and the width of the security thread 352, as well as the relative arrangement of the two openings and potential features of the security thread, a plurality of possible embodiments exist that all can be produced with the paper machine 370 in FIG. 31 (or in other embodiments with a paper machine in which the first paper ply is produced by a direct-current mold).

In a first variant are produced in the pressure-former ply by the first drawing-off device 380 openings 356 that can constitute any shapes, for example also characters, symbols or the like. A thread 352 that rests on an e-type is introduced at the countercurrent cylinder mold 374. Here, the e-type is chosen to be so high that fibers can “swim” under the introduced thread and the thread thus lies open in the region of the e-types. In this variant, the countercurrent cylinder mold openings 354 are always formed to be narrower than the thread width. The shapes of the pressure-form-ply opening 356 can be narrower than the thread width, as shown in FIG. 32(a), or also wider. The openings 356 can be oriented in the exact position as the countercurrent cylinder mold openings 354, as shown in FIG. 32(a) left, or lie randomly between these openings or overlap with them. In the first case, this variant shows a see-through window whose size is limited by the openings 354 in the countercurrent-cylinder-mold ply, see FIG. 32(b). In reflected light, the desired shape 356 is perceptible only from the side of the pressure-form ply. In the second case, this variant provides a substrate in which the introduced security thread 352 lies partially open on both sides. A see-through window then forms only when opposing openings chance to overlap.

In a second variant that is depicted in plan view in FIG. 33, the openings 354 in the countercurrent-cylinder-mold ply are always formed to be larger than the openings 356 in the pressure-former ply, the openings 354 being able to be narrower or wider than the thread width. The pressure-former-ply openings 356 can be disposed in the exact position as the openings 354, as in FIG. 33, or lie randomly between these openings or overlap with them. A see-through window results only for the exactly positioned alignment of the two openings. In this case, the shape of the pressure-former-ply openings 356 is visible from both sides of the substrate. If the openings are not aligned in exact positioning with each other, a substrate again results having a security thread 352 that lies partially open on both sides.

In a third variant depicted in FIG. 34, openings 356 are introduced into the pressure-former ply as described above, while the countercurrent cylinder mold exhibits neither e-types nor an embossing. Through a register control that can occur, for example, with the aid of register marks 362, the openings 356 in the pressure-former ply are aligned with certain sites of the security thread 352 fed in at the countercurrent cylinder mold. For example, an inverse lettering 364 of the security thread 352 can become visible in the openings 356 in the pressure-former ply.

According to a fourth variant that is shown in cross section in FIG. 35, openings 356 are introduced into the pressure-former ply 358 and a security thread 352 is fed in at the countercurrent cylinder mold. Here, the countercurrent cylinder mold 374 is provided with an embossing whose ridges are preferably in register with the pressure-former-ply openings 356 such that the produced window openings 354 in the countercurrent-cylinder-mold ply 360 and the openings 356 in the pressure-former ply 358 alternate on both substrate sides.

According to a fifth variant, first, an opening is introduced into the pressure-former ply in the manner described, and the pressure-former ply and the countercurrent-cylinder-mold ply are couched with the security thread. After the removal of the entire paper ply, an opening is drawn out by a second drawing-off device 382 in the region of the security thread. The openings of the two paper plies can be disposed in register with each other or randomly.

The sixth variant is similar to the third variant, but the countercurrent cylinder mold in this variant is provided with a watermark embossing that falls on the region of the thread running in. With the first drawing-off device 380, openings of any shape are drawn out of the pressure-former-ply such that the thread is exposed in the drawn-out sites. By registering the watermark and pressure-former-ply openings, it can be achieved, for example, that the watermarks of the countercurrent-cylinder-mold ply lie around the drawn-out openings.

Instead of suctioning shapes out of the first or second paper web, it is also possible to reverse the suction mechanism of the first and/or second device 380, 382 and to apply material to the paper ply. For example, any shaped openings of the device 380 can be filled with a material, such as fibers, plastic granules or rubber, and the material transferred to the wet pressure former web through positive pressure or adhesion. Thereafter, the paper web is couched with the countercurrent-cylinder-mold ply with thread. The introduced material then appears in transmitted light as a dark shape. If an oil is applied as the material, the shape can also appear semi-transparent in the dried substrate.

The diameter of the first or second drawing-off device 380, 382 is dependent on the sheet length and is expediently chosen to be as large as possible to keep the circulation speed as low as possible. However, the maximum possible diameter is also limited by the space conditions between the pressure former 372 and the countercurrent cylinder mold 374. Since, for a small diameter, the surface of contact with the pressure-former ply 384 will likewise be small, it can be advisable, especially in cramped space conditions, to design the drawing-off device 380 to be, not round, but rather trapezoidal or triangular, as shown in FIG. 36. In this embodiment of the drawing-off device 380, drawing-off shapes 386 are affixed on a flexible base material 388. In the exemplary embodiment, the drive takes place via a chain 390.

Particularly expedient embodiments of a drawing-off device 380 according to the present invention will now be described with reference to FIGS. 37 to 39. The exemplary embodiments shown depict a suction wheel 380 that is made up of multiple segments 400 to 406. FIG. 37 shows a section of a suction wheel 380 in side view, FIG. 38 a similar suction wheel 380 having a somewhat different embodiment of the extraction openings 408 or channels 414 in the region of such an opening, as viewed from above, and FIGS. 39(a) and (b), side views of the middle segments 402 and 404 in FIG. 38, looking toward lines A-A and B-B in FIG. 38. Here, the sites marked with reference numbers 416 and 418 indicate the visible edges in the cross sectional views in FIGS. 39(a) and (b). The side view shown in FIG. 37 corresponds to the side view of the cover plate 406 looking toward line C-C in FIG. 38.

The suction wheel 380 exhibits a sandwich structure composed of multiple segment plates, through which a plurality of designs for the extraction openings 408 can be achieved. In the exemplary embodiment, the suction wheel consists of a first cover plate 400, two intermediate plates 402 and 404, and a further cover plate 406. The plates 400 to 406 can be composed of metal or an impact resistant, not too brittle plastic, and manufactured with the aid of a laser beam, a water jet or a similar technique. The plates are screwed, a spray sealant and/or gaskets being used for sealing, if applicable. The circumference of the suction wheel 380 corresponds to the sheet length of the paper ply to be processed, in the wet state. After screwing, the suction wheel 380 is put on a guide shaft, not shown, and fixed. If needed, multiple suction wheels can also be slid onto the guide shaft and fixed. The guide shaft is centrally driven and, in preferred embodiments, runs synchronously with the web speed.

After the start of the paper machine, the suction wheel 380 also starts, is brought up to production speed, and placed at the pressure-former web 384 until, due to the drawing off, openings form in the pressure-former web. Here, the elevated sites 410 perceptible in FIG. 37 and FIG. 39(a) pierce the still wet paper web and an opening of the desired shape is drawn off through the extraction opening 408 by an applied partial vacuum. To prevent the sticking of fibers on the surface of the suction wheel 380, the regions adjacent to the extraction openings 408 can be recessed.

The drawing off of the material/water mixture occurs through the extraction opening 408 and a channel 414 that extends through the intermediate plate 404 to the cover plate 406. To securely remove the drawn off material, the extraction openings 408 and the channels 414 must be cleaned. For this, for example, a tub 392 having filtered water (FIG. 31) can be provided that the suction wheel 380 passes through in the region opposite the drawing off. In the exemplary embodiment, the vacuum is applied with a fixed vacuum device 394 (FIG. 31) that drags on the surface of the cover plate 406. In this way, the drawing off operates in each case, via one of the channels 414, only at the extraction opening 408 that is in contact with the paper web 384.

As is best perceptible in FIG. 38, the sandwich structure composed of multiple segment plates facilitates a nearly unlimited design for the extraction openings 408. Here, the intermediate plates, which can be assembled in any number, produce the shape of the extraction openings per se. The width of the opening can be set through the number and thickness of the intermediate plates. For example, a 10 mm wide opening can be produced by two intermediate plates of 5 mm, or also by five intermediate plates of 2 mm. The cover plates 400, 406 serve the edge delimitation and the application of the vacuum. While, in FIG. 38, only a cover plate 406 exhibits a channel opening, such openings can, of course, also be provided in both cover plates, a vacuum device 394 then having to be disposed on both sides of the suction wheel 380.

It is understood that the described embodiment can also be used for the second drawing-off device 382.

The drawing-off devices 380 and 382 can also be covered with a flexible plastic mask in which not only comparatively crude, but also very fine patterns, such as alphanumeric or abstract characters, can be uncovered. In this way, also continuous patterns, such as meander shapes or continuous texts, or also patterns disposed in perfect register, such as value indications in a banknote, can be produced in the paper plies. Here, the cited patterns can be disposed in one of the paper plies or disposed congruently or offset in both paper plies.

1. A multi-ply security paper for manufacturing security or value documents, such as banknotes, identification cards and the like, in which
into a first paper ply is introduced an endless security element that is freely accessible on at least one side of the paper ply,
the first paper ply is covered on the freely accessible side of the security element by a second paper ply,
the second paper ply exhibits one or more openings in the region of the security element,
characterized in that
the first paper ply exhibits a watermark and the second paper ply is interrupted in the region of the watermark.

2. The security paper according to claim 1, characterized in that the measure of the opening(s) perpendicular to the running direction of the endless security element is less than its width.

3. The security paper according to claim 1, characterized in that the endless security element is furnished with optically variable effects, especially with a diffraction pattern, a hologram, a color-shift effect or another interference layer effect.

4. The security paper according to claim 1, characterized in that the endless security element is provided with a print image, especially positive or inverse characters.

5. The security paper according to claim 1, characterized in that the endless security element is a wide security band that divides the first paper ply.

6. The security paper according to claim 1, characterized in that the endless security element is a narrow security strip that is embedded in the first paper ply.

7. The security paper according to claim 1, characterized in that the first paper ply exhibits a grammage of 60 to 80 g/m², especially of 65 to 70 g/m², and the second paper ply exhibits a grammage of 15 to 45 g/m², especially of 20 to 25 g/m².

8. The security paper according to claim 1, characterized in that the first paper ply exhibits a grammage of 15 to 45 g/m², especially of 20 to 25 g/m², and the second paper ply exhibits a grammage of 60 to 80 g/m², especially of 65 to 70 g/m².

9. The security paper according to claim 1, characterized in that the endless security element is fixed in the first paper ply with an adhesive.

10. The security paper according to claim 1, characterized in that the second paper ply exhibits a strip-shaped opening in the region of the security element.

11. The security paper according to claim 10, characterized in that the strip-shaped opening is closed with a tear-openable release strip.

12. The security paper according to claim 1, characterized in that the openings in the second paper ply are filled with a transparent material, especially a polyurethane adhesive.

13. A method for manufacturing a security paper according to claim 1, characterized in that
a first paper web is formed, and an endless security element is introduced into the first paper web such that the endless security element is freely accessible at least on one side of the paper web,
a watermark is introduced into the first paper web,
a second paper web is formed that, while still in the wet state, is merged and firmly joined with the first paper web such that it covers the freely accessible side of the security element,
wherein into the second paper web are introduced one or more openings that, after the merger with the first paper web, come to lie in the region of the endless security element,
and wherein into the second paper web is further introduced an interruption that, after the merger with the first paper web, comes to lie in the region of the watermark.

14. The method according to claim 13, characterized in that the first and/or second paper web is produced in a direct-current cylinder mold paper machine.

15. The method according to claim 13, characterized in that the first and/or second paper web is produced in a pressure former, in which the paper pulp is jetted onto a cylinder mold.

16. The method according to claim 13, characterized in that the second paper web is produced on a cylinder mold whose holes are closed in sub-areas.

17. The method according to claim 16, characterized in that the holes of the cylinder mold are closed by applying, especially affixing, a cover strip.

18. The method according to claim 16, characterized in that the holes of the cylinder mold are closed by partially imprinting a lacquer layer.

19. The method according to claim 16, characterized in that the holes of the cylinder mold are closed by a cover ring abutting the surface of revolution of the cylinder mold from inside.

20. The method according to claim 16, characterized in that the endless security element runs onto the cylinder mold and closes the holes of the cylinder mold at the sites run onto.

21. The method according to claim 13, characterized in that the endless security element is fixed in the first paper ply with an adhesive.

22. The method according to claim 13, characterized in that into the second paper ply is introduced a strip-shaped opening and, if applicable, said opening is closed with a tear-openable release strip at paper manufacture.

23. The method according to claim 13, characterized in that the openings in the second paper ply are filled with a transparent material, especially a polyurethane adhesive.

24. A multi-ply security paper for manufacturing security or value documents, such as banknotes, identification cards and the like, characterized in that at least two paper plies produced with different fibers are combined.

25. The security paper according to claim 24, characterized in that the at least two paper plies produced with different fibers are formed having complementary interruptions, and complement one another to form a combination paper ply that exhibits no greater thickness than the at least two individual layers.

26. The security paper according to claim 24, characterized in that the at least two paper plies produced with different fibers exhibit interruptions in the form of vertical or horizontal strips and are stacked in the security paper.

27. The security paper according to claim 24, characterized in that the at least two paper plies are formed from fibers of different colors, different lengths or from fibers having different feature additives.

28. The security paper according to claim 24, characterized in that a first paper ply including a watermark is formed from short fibers, and a second, thinner paper ply for increasing the tensile strength is formed from long fibers.

29. The security paper according to claim 28, characterized in that the first paper ply composed of short fibers is embedded between two thinner paper plies having long fibers.

30. The security paper according to claim 24, characterized in that a first paper ply including a watermark is covered by a second paper ply that, in the region of the watermark, is formed having transparent fibers, and outside the region of the watermark, having common, non-transparent fibers.

31. The security paper according to claim 24, characterized in that the at least two paper plies produced having different fibers are combined with further contiguous or interrupted paper plies.

32. The security paper according to claim 24, characterized in that the at least two paper plies produced having different fibers are combined with a security element that is visible through the paper plies at least in a sub-area.

33. A method for manufacturing a security paper, characterized in that
in a first wet end of a paper machine, a first paper web is formed and, if applicable, provided with individualization features, such as an opening or a watermark,
in a second wet end of a paper machine, a second paper web is formed,
the second paper web is merged and firmly joined with the first paper web via a pickup belt, and that
from the second paper web, still in the wet state, paper fibers are removed by means of a suction apparatus, preferably in register with any existing individualization features of the first paper web.

34. The method according to claim 33, characterized in that the fibers of the second paper web are only partially removed by the suction apparatus to produce regions of smaller thickness in the second paper web.

35. The method according to claim 34, characterized in that the regions of reduced thickness in the second paper web are produced in register with watermark regions in the first paper web.

36. The method according to claim 33, characterized in that the fibers of the second paper web are completely removed by the suction apparatus to produce openings in the second paper web.

37. The method according to claim 36, characterized in that the openings in the second paper web are produced in register with openings in the first paper web, and especially complement each other to form see-through holes.

38. The method according to claim 36, characterized in that the register-accurate openings in the first and second paper web are combined with a security element whose respective security features are perceptible from both sides of the security paper.

39. The method according to claim 38, characterized in that the security element is a two-sided security element, especially a swing security thread, a double hologram security thread or a double-ink-layer security thread.

40. The method according to claim 38, characterized in that the security element is introduced between the first and second paper web.

41. The method according to claim 33, characterized in that the suction apparatus draws off the paper fibers of the second paper web on its way to the first paper web.

42. The method according to claim 33, characterized in that the suction apparatus draws off the paper fibers of the second paper web after the merger with the first paper web, preferably through openings in the first paper web.

43. The method according to claim 33, characterized in that the first paper web is produced on a cylinder mold, and the suction apparatus is driven in register with the cylinder mold of the first paper web.

44. The method according to claim 33, characterized in that the suction apparatus is formed in the shape of a trapezoid or triangle.

45. The method according to claim 33, characterized in that the suction apparatus is formed as a suction wheel composed of multiple segment plates.

46. A suction apparatus for producing thin sites or openings in a wet paper web at paper manufacture, having extraction openings for drawing a material/water mixture out of the wet paper web, characterized in that the suction apparatus is formed by a suction wheel, composed of multiple segment plates, in which are provided at least one intermediate plate forming the extraction openings, and two cover plates forming edge delimiters.

47. The suction apparatus according to claim 46, characterized in that at least a portion of the segment plates having the extraction openings each exhibit connected channels for drawing off the material/water mixture.

48. The suction apparatus according to claim 46, characterized in that the regions adjoining the extraction openings in the intermediate plates are recessed.

49. The suction apparatus according to claim 47, characterized in that a fixed vacuum device is provided that, in operation, drags on the surface of at least one of the cover plates of the rotating suction wheel and that, for drawing off, is connected via one of the channels with the extraction opening that is in contact with the paper web in each case.

50. The suction apparatus according to claim 46, characterized in that the drawing off device is covered with a flexible plastic mask that, in the region of the extraction openings, exhibits gaps in the form of patterns, characters or codes.

51. A method for manufacturing a security paper, in which, in a wet end of a paper machine, a paper web is formed on a cylinder mold and lifted up from the cylinder mold by means of a carrier belt, characterized in that the lifting up of the paper web is supported by a suction device disposed in the immediate vicinity of the cylinder mold and at a short distance from the carrier belt.

52. The method according to claim 51, characterized in that, in the suction device, a negative pressure is produced that is greater than the negative pressure in the interior of the cylinder mold by at least 0.1 bar, preferably by about 0.2 bar.

53. The method according to claim 51, characterized in that the suction device is formed by a rotatable suction roll that is preferably driven in register-accurate synchronism with the cylinder mold of the wet end.

54. The method according to claim 53, characterized in that the suction roll exhibits a perforated roll shell that is surrounded by a perforated rubber blanket and a felt of defined permeability.

55. The method according to claim 51, characterized in that a watermark is introduced into the paper web on the cylinder mold.

56. The method according to claim 55, characterized in that, in the region of the watermark, the distance of the suction device to the cylinder mold is adapted to the local paper thickness.

57. A mold, for manufacturing paper in a paper machine, that exhibits elevations and depressions for producing watermark regions, characterized in that, in the depressions, patterns are provided that facilitate the paper detachment from the mold.

58. The mold according to claim 57, characterized in that the elevations and depressions for producing bar watermarks are disposed bar-like next to one another.

59. The mold according to claim 57, characterized in that the patterns are formed by grooves, especially by grooves milled into the depressions.

60. A method for producing a through opening in a multi-ply security paper, characterized in that
a first paper web is formed and provided with an opening,
a second contiguous paper web is formed that, still in the wet state, is merged with the first paper web,
the merged first and second paper web are guided between a first- and a second-web-side carrier felt, and
the second-web-side carrier felt is lifted up from the merged paper web to pick up a sub-area of the second paper web in the region of the opening of the first paper web and, in this way, to produce a through opening in the merged paper web.

61. The method according to claim 60, characterized in that the second-web-side carrier felt is acted on with a suction pressure S₂, and the first-web-side carrier felt is acted on in the regions outside the opening with a suction pressure S₁ that is greater than S₂.

62. The method according to claim 60, characterized in that the first-web-side carrier felt is acted on in the region of the opening with a counter blowing pressure, especially an air jet, water jet or a laser beam.

63. A multi-ply security paper for manufacturing security or value documents, such as banknotes, identification cards and the like, characterized in that, in at least a first paper ply of the security paper, a luminescent substance and, if applicable, a further feature substance are homogeneously distributed in the volume of the paper ply, and this first paper ply exhibits, at least in a sub-area, at least two different paper thicknesses.

64. The security paper according to claim 63, characterized in that a second paper ply of the security paper exhibits different paper thicknesses, at least in sub-areas.

65. The security paper according to claim 64, characterized in that the paper thickness variations in the first and second paper ply complement one another to form a constant total thickness of the security paper.

66. The security paper according to claim 63, characterized in that the different paper thicknesses are not visually perceptible.

67. The security paper according to claim 63, characterized in that the regions having different paper thicknesses are at least partially overprinted.

68. The security paper according to claim 63, characterized in that the different paper thicknesses are present as a watermark.

69. The security paper according to claim 68, characterized in that the watermark is a bar watermark.

70. The security paper according to claim 63, characterized in that the different paper thicknesses are produced by incorporating windows.

71. The security paper according to claim 63, characterized in that the first paper ply includes multiple luminescent substances.

72. The security paper according to claim 63, characterized in that the second paper ply includes the same luminescent substance as the first ply and/or at least one luminescent substance that differs from the luminescent substance of the first ply.

73. The security paper according to claim 63, characterized in that the luminescent substance(s) are transparent in the visual spectral range.

74. The security paper according to claim 63, characterized in that the first and/or second ply comprises at least one further feature substance.

75. The security paper according to claim 63, characterized in that the feature substance comprises at least one further substance having machine-readable properties.

76. The security paper according to claim 75, characterized in that the machine-readable property is an electric and/or magnetic property.

77. A method for manufacturing a multi-ply security paper according to claim 63 having at least one luminescent substance and, if applicable, at least one further feature substance, characterized in that the at least one luminescent substance and the, if applicable, at least one further feature substance is homogeneously distributed in the volume of the paper pulp used for the manufacture of the first paper ply, and at least two different paper thicknesses are incorporated, at least in a sub-area, in the manufacture of the first paper ply.

78. A method for checking the authenticity of a security paper according to claim 63, characterized in that the luminescent properties of the security paper are measured by means of a sensor.

79. The method for checking the authenticity of a security paper according to claim 78, characterized in that, additionally, at least one machine-readable property of the at least one further feature substance is measured by means of a sensor.

80. A method for checking the authenticity of a security paper according to claim 79, characterized in that an electric and/or magnetic property is measured as the machine-readable property.
